(19) United States
(12) Patent Application Publication
(10) Pub. No.: US 2010/0031014 A1
(43) Pub. Date: Feb. 4, 2010

(54) INFORMATION CONCEALING DEVICE, METHOD, AND PROGRAM

(76) Inventor: Shuji Senda, Tokyo (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(21) Appl. No.: 12/448,046

(22) PCT Filed: Dec. 5, 2007
(86) PCT No.: PCT/JP2007/073446

§ 371 Date: Aug. 24, 2009

(30) Foreign Application Priority Data
Dec. 6, 2006 (JP) 2006-329486

(51) Int. Cl. H04L 9/00; G06K 9/00

(52) U.S. Cl. 713/150; 382/100; 713/189

(57) ABSTRACT

An information concealing device comprises a mask means for prompting the user to specify a secret area in an input image, a secret area specifying means for generating image data describing the image of the specified area in the input image and describing an area other than the specified area in a single color, an encoding means for converting the image data, which describes the image of the specified area in the input image and describes an area other than the specified area in a single color, to image data describing a code, and an embedding means for generating the image data of an image describing the specified area in the input image in a single color and embedding the code into the image.

### APPLICABLE FIELD IN THE INDUSTRY

The present invention relates to an information concealing device for concealing image information, and an information recovering device for putting concealed image information into a readable status, as well as an information concealing method, an information concealing program, an information recovering method, and an information recovering program each of which is applied for these devices.

### BACKGROUND ART

In recent years, a trend for preventing information from leaking out to a third person by taking countermeasures such as encryption of information and prohibition of taking-out of information has been found due to a rise in security awareness.

As a prior art for preventing information from leaking, for example, there exists the filter for preventing peeping by narrowing a viewing angle.

Further, the display security securing device is disclosed in Patent document 1 for enabling only a person who puts on spectacles with liquid crystal shutters to peruse information without recognizing flickering of a display screen owing to the spectacles by making a white display on a display device, and closing the shutters of the spectacles with liquid crystal shutters simultaneously therewith, thereby allowing a person other than the person who puts on a spectacles with liquid crystal shutters to recognize that the white display is displayed flickering, and preventing him/her from viewing information.

Further, the image encrypting method and device in which the encrypting side encrypts the selected part, out of the image, and embeds it into the selected part of the original image data, and the side having received the above image extracts the encrypted part, processes the encrypted data into a plain text, and restores the part converted into the plain text to the original data are disclosed in Patent document 2.

Further, the process ranging a process of coding the two-dimensional code to a process of printing it, and a process of reading off the two-dimensional code are disclosed in Patent document 3.

Patent document 1: JP-P2000-310965A

Patent document 2: JP-P2000-315998A

Patent document 3: JP-P1995-254037A

### DISCLOSURE OF THE INVENTION

### Problems to be Solved by the Invention

Also in the case of installing the filter for preventing peeping by narrowing a viewing angle in the display device, when a third person exists behind an information reader, the above third person could peep information because some gap exists between eyes of the information reader and the display device. Further, transmittivity declines due to existence of the filter. That is, an amount of light that reaches the information reader from the display device in the case that the filter exists is decreased as compared with the case that no filter exists. Thus, the displayed information looks poor from a viewpoint of the information reader itself.

Further, the device disclosed in the Patent document 1 requests that a displaying operation of the display device and a shuttering operation of the spectacles with liquid crystal shutters should be synchronized with each other at a high precision, and for this, it is essential to exchange a synchronous signal between these devices with a wire technique or a wireless technique. Further, the light amount being used for the display is decreased as compared with the normal case because of the technique of switching the display at a high speed, which causes the displayed information to look poor.

Further, the technology disclosed in the Patent document 2 is a technology of transmitting the image data in which one part of the image has been encrypted. Herein, the encrypted data is digital data. Thus, there is a restraint that the device on a sender side for encrypting one part of the image and the device on a receiver side that the person who peruses the image uses need to be in a status where they can transmit/receive the digital data to/from each other via a communication network etc. For example, when the device on the sender side and the device on the receiver side cannot make communication with each other via the communication network etc., a user of the device on the receiver side cannot peruse the image. Further, the image including the encrypted data as well cannot be sent as a printed matter to the user of the device on the receiver side because the digital data cannot be outputted as a printed matter.

Thereupon, the present invention has an object of providing a technology for attaining the status in which only one part of the information is made unreadable by the third person by alleviating the restraint putted upon the device on the sender side for concealing and transmitting the information, and the device on the receiver side that the person who peruses the information uses.

### Means to Solve the Problems

The present invention for solving the above-mentioned problems, which is an information concealing device, is characterized in including: a masking means for urging a user to designate a region being concealed in an input image, being an image that has been inputted; a concealment region specifying means for generating image data that expresses the image of the region designated in the input image, and expresses the region other than the designated region in a single color; a coding means for converting the image data, which expresses the image of the region designated in the input image, and expresses the region other than the designated region in a single color, into the image data expressing a code; and an embedding means for generating the image data of the image that expresses the region designated in the input image in a single color, and embedding the code into the foregoing image.

The present invention for solving the above-mentioned problems, which is an information concealing device that is connected to a data server for storing image data, and puts an image into a unreadable status, is characterized in including: a masking means for urging a user to designate a region, which should be concealed, in an input image, being an image that has been inputted; a concealment region specifying means for generating image data that expresses the image of the region designated in the input image, and expresses the region other than the designated region in a single color; a data storage instructing means for transmitting the image data, which expresses the image of the region designated in the input image, and expresses the region other than the designated region in a single color, to the data server, and causing the data server to store it; a coding means for converting an address of the image data stored to the data server into the image data expressing a code; and an embedding means for generating the image data of the image that expresses the region designated in the input image in a single color, and embedding the code into the foregoing image.

The present invention for solving the above-mentioned problems, which is an information recovering device for recovering an hidden image from a concealment image including the code, of which one part has been hidden, is characterized in including: a decoding means for decoding the code being included in the concealment image to before-coding data; and an image data generating means for generating the image data of the image having the hidden image included within the concealment image thereof by employing the decoded data and the image data of the concealment image.

The present invention for solving the above-mentioned problems, which is an information recovering device that recovers an hidden image from a concealment image including the code, of which one part has been hidden, and has been connected to a data server for storing image data, is characterized in including: a decoding means for decoding the code being included in the concealment image to a before-coding address; a data requesting means for transmitting the foregoing address to the data server, and receiving image data corresponding to the foregoing address from the data server; and an image data generating means for generating the image data of the image having the hidden image included within the concealment image thereof by employing the image data received by the data requesting means and the image data of the concealment image.

The present invention for solving the above-mentioned problems, which is an information concealing method, is characterized in that: a masking means urges a user to designate a region, which should be concealed, in an input image, being an image that has been inputted; a concealment region specifying means generates image data that expresses the image of the region designated in the input image, and expresses the region other than the designated region in a single color; a coding means converts the image data, which expresses the image of the region designated in the input image, and expresses the region other than the designated region in a single color, into the image data expressing a code; and an embedding means generates the image data of the image that expresses the region designated in the input image in a single color, and embeds the code into the foregoing image.

The present invention for solving the above-mentioned problems, which is an information concealing method, is characterized in that: a masking means urges a user to designate a region, which should be concealed, in an input image, being an image that has been inputted; a concealment region specifying means generates image data that expresses the image of the region designated in the input image, and expresses the region other than the designated region in a single color; a data storage instructing means transmits image data, which expresses the image of the region designated in the input image, and expresses the region other than the designated region in a single color, to a data server, and causes the data server to store it; a coding means converts an address of the image data stored to the data server into image data expressing a code; and an embedding means generates the image data of the image that expresses the region designated in the input image in a single color, and embeds the code into the foregoing image.

The present invention for solving the above-mentioned problems, which is an information recovering method, is characterized in that: a decoding means decodes a code within a concealment image including the code, of which one part has been hidden, to before-coding data; and an image data generating means generates image data of the image having the hidden image included within the concealment image thereof by employing the decoded data and the image data of the concealment image.

The present invention for solving the above-mentioned problems, which is an information recovering method, is characterized in that: a decoding means decodes a code within a concealment image including the code, of which one part has been hidden, to a before-coding address; a data requesting means transmits the foregoing address to a data server and receives image data corresponding to the foregoing address from the data server; and an image data generating means generates the image data of the image having the hidden image included within the concealment image thereof by employing the image data received by the data requesting means and the image data of the concealment image.

The present invention for solving the above-mentioned problems is an information concealing program for causing a computer to execute: a masking process of urging a user to designate a region, which should be concealed, in an input image, being an image that has been inputted; a concealment region specifying process of generating image data that expresses the image of the region designated in the input image, and expresses the region other than the designated region in a single color; a coding process of converting the image data, which expresses the image of the region designated in the input image, and expresses the region other than the designated region in a single color, into image data expressing a code; and an embedding process of generating the image data of the image that expresses the region designated in the input image in a single color and embedding the code into the foregoing image.

The present invention for solving the above-mentioned problems is an information concealing program for causing a computer to execute: a masking process of urging a user to designate a region, which should be concealed, in an input image, being an image that has been inputted; a concealment region specifying process of generating image data that expresses the image of the region designated in the input image, and expresses the region other than the designated region in a single color; a data storage instructing process of transmitting the image data, which expresses the image of the region designated in the input image, and expresses the region other than the designated region in a single color, to a data server, and causing the data server to store it; a coding process of converting an address of the image data stored to the data server into image data expressing a code; and an embedding means for generating the image data of the image that expresses the region designated in the input image in a single color, and embedding the code into the foregoing image.

The present invention for solving the above-mentioned problems is an information recovering program for causing a computer to execute: a decoding process of decoding a code within a concealment image including the code, of which one part has been hidden, to before-coding data; and an image data generating process of generating the image data of the image having the hidden image included within the concealment image thereof by employing the decoded data and the image data of the concealment image.

The present invention for solving the above-mentioned problems is an information recovering program for causing a computer to execute: a decoding process of decoding a code within a concealment image including the code, of which one part has been hidden, to a before-coding address; a data requesting process of transmitting the foregoing address to a data server and receiving image data corresponding to the foregoing address from the data server; and an image data generating process of generating the image data of the image having the hidden image included within the concealment image thereof by employing the image data received in the data requesting process and the image data of the concealment image.

### AN ADVANTAGEOUS EFFECT OF THE INVENTION

The present invention makes it possible to attain the status in which only one part of the information is made unreadable by the third person by alleviating the restraint putted upon the device on the sender side for concealing and transmitting the information, and the device on the receiver side that the person who peruses the information uses.

### BRIEF DESCRIPTION OF THE DRAWINGS

FIG. 1 is a block diagram illustrating an example of the information concealing device of a first embodiment.

FIG. 2 is a block diagram illustrating an example of the information recovering device of the first embodiment.

FIG. 3 is a flowchart illustrating an example of a processing flow of the information concealing device of the present invention.

FIG. 4 is an explanatory view schematically illustrating an operation of a step S2.

FIG. 5 is an explanatory view illustrating an example of a shape of the region that is designated by a user on a concealing side.

FIG. 6 is an explanatory view illustrating an example of generating position-aligning information.

FIG. 7 is an explanatory view schematically illustrating a process that is performed by a first embedding means.

FIG. 8 is a flowchart illustrating an example of a processing flow of the information recovering device of the present invention.

FIG. 9 is a block diagram illustrating an example of the information concealing device of a second embodiment.

FIG. 10 is a block diagram illustrating an example of the information recovering device of the second embodiment.

### DESCRIPTION OF NUMERALS

11 concealing device side image inputting means

### (First Inputting Means)

12 masking means
13 concealment region specifying means
14 image compressing means
15 encrypting means
16 coding means
17 concealing device side image embedding means

### (First Embedding Means)

18 concealing device side image outputting means

### (First Outputting Means)

19 concealing device side key storing means (first key storing means)
31 recovering device side image inputting means

### (Second Inputting Means)

32 code region specifying means
33 decoding means
34 deciphering means
35 image expanding means
36 recovering device side image embedding means

### (Second Embedding Means)

37 recovering device side image outputting means

### (Second Outputting Means)

39 recovering device side key storing means (second key storing means)

### BEST MODE FOR CARRYING OUT THE INVENTION

Special features of the present invention will be explained.

The information concealing device of the present invention is characterized in including: a masking means for urging a user to designate a region, which should be concealed, in an input image, being an image that has been inputted; a concealment region specifying means for generating image data that expresses the image of the region designated in the input image, and expresses the region other than the designated region in a single color; a coding means for converting the image data, which expresses the image of the region designated in the input image, and expresses the region other than the designated region in a single color, into the image data expressing a code; and an embedding means for generating the image data of the image that expresses the region designated in the input image in a single color, and embedding the code into the foregoing image.

Alleviating the restraint putted upon the device on the sender side for concealing and transmitting the information, and the device on the receiver side that the person who peruses the information uses makes it possible to attain the status in which only one part of the information is made unreadable by the third person because the image having the code embedded therein is printable.

The information concealing device may be configured so that it includes an image compressing means for compressing the image data generated by the concealment region specifying means, and the coding means converts the compressed image data into the image data expressing the code.

The information concealing device may be configured so that it includes an encrypting means for encrypting the image data generated by the concealment region specifying means, and the coding means converts the encrypted image data into the image data expressing the code.

The information concealing device may be configured so that it includes an image compressing means for compressing the image data generated by the concealment region specifying means, and an encrypting means for encrypting the compressed image data, and the coding means converts the encrypted image data into the image data expressing the code.

The information concealing device may be configured so that the image compressing means generates resolution-lowered image data from the image data generated by the concealment region specifying means, and compresses both of first image data generated by the concealment region specifying means and resolution-lowered second image data, the encrypting means encrypts both of the compressed first image data and the compressed second image data, and the coding means converts the compressed and encrypted first image data into the image data expressing a two-dimensional code, and converts the compressed and encrypted second image data into the image data expressing a two-dimensional code of which a cell is larger than that of the foregoing two-dimensional code.

Such a configuration makes the high-resolution image recoverable when the decoding of each of two kinds of the two-dimensional codes has succeeded at the moment of recovering the concealed image, and makes the low-resolution image recoverable when the decoding of only the two-dimensional code of which the cell is larger has succeeded.

Further, the information concealing device of the present invention, which is an information concealing device that is connected to a data server for storing image data, and puts an image into a unreadable status, is characterized in including: a masking means for urging a user to designate a region, which should be concealed, in an input image, being an image that has been inputted; a concealment region specifying means for generating image data that expresses the image of the region designated in the input image, and expresses the region other than the designated region in a single color; a data storage instructing means for transmitting the image data, which expresses the image of the region designated in the input image, and expresses the region other than the designated region in a single color, to the data server, and causing the data server to store it; a coding means for converting an address of the image data stored to the data server into the image data expressing a code; and an embedding means for generating the image data of the image that expresses the region designated in the input image in a single color, and embedding the code into the foregoing image.

Alleviating the restraint putted upon the device on the sender side for concealing and transmitting the information, and the device on the receiver side that the person who peruses the information uses makes it possible to attain the status in which only one part of the information is made unreadable by the third person because the image having the code embedded therein is printable. Further, even though the region of the image being concealed is large, the code can be made small because the address is coded.

The information concealing device may be configured so that it includes an image compressing means for compressing the image data generated by the concealment region specifying means, and the data storage instructing means transmits the compressed image data to the data server and causes the data server to store it.

The information concealing device may be configured so that it includes an encrypting means for encrypting the image data generated by the concealment region specifying means, and the data storage instructing means transmits the encrypted image data to the data server and causes the data server to store it.

The information concealing device may be configured so that it includes an image compressing means for compressing the image data generated by the concealment region specifying means, and an encrypting means for encrypting the compressed image data, and the data storage instructing means transmits the encrypted image data to the data server and causes the data server to store it.

The information concealing device may be configured so that the image compressing means generates resolution-lowered image data from the image data generated by the concealment region specifying means, and compresses both of first image data generated by the concealment region specifying means and resolution-lowered second image data, the encrypting means encrypts both of the compressed first image data and the compressed second image data, the data storage instructing means transmits the compressed and encrypted first image data to the data server and causes the data server to store it, and the coding means converts each of the address of the image data stored to the data server and the compressed and encrypted second image data into the image data expressing the code.

Such a configuration makes it possible to select whether the concealed image is recovered as a high-resolution image or is recovered as a low-resolution image at the moment of recovering it.

The information recovering device of the present invention, which is an information recovering device for recovering an hidden image from a concealment image including the code, of which one part has been hidden, is characterized in including: a decoding means for decoding the code being included in the concealment image to before-coding data; and an image data generating means (for example, the recovering device side image embedding means 36) for generating the image data of the image having the hidden image included within the concealment image thereof by employing the decoded data and the image data of the concealment image.

The information recovering device may be configured so that it includes an image expanding means for expanding the compressed data to the before-compression data, the image expanding means expands the decoded data to the before-compression image data, and the image data generating means generates the image data of the image having the hidden image included within the concealment image thereof by employing the expanded image data and the image data of the concealment image.

The information recovering device may be configured so that it includes a deciphering means for decrypting the encrypted data, the deciphering means decrypts the decoded data, and the image data generating means generates the image data of the image having the hidden image included within the concealment image by employing the decrypted image data and the image data of the concealment image.

The information recovering device may be configured so that it includes a deciphering means for decrypting the encrypted data and an image expanding means for expanding the compressed data to the before-compression data, the deciphering means decrypts the decoded data, the image expanding means expands the decrypted data to the before-compression image data, and the image data generating means generates the image data of the image having the hidden image included within the concealment image thereof by employing the expanded image data and the image data of the concealment image.

The information recovering device may be configured so that the decoding means decodes two kinds of two-dimensional codes, i.e. a first two-dimensional code being included in the concealment image, and a second two-dimensional code of which a cell is larger than that of the foregoing first two-dimensional code, and the deciphering means decrypts the data decoded from the first two-dimensional code when the decoding means has succeeded in decoding each of the first two-dimensional code and the second two-dimensional code.

The information recovering device of the present invention, which is an information recovering device that recovers an hidden image from a concealment image including the code, of which one part has been hidden, and has been connected to a data server for storing image data, is characterized in including: a decoding means for decoding the code being included in the concealment image to a before-coding address; a data requesting means for transmitting the foregoing address to the data server, and receiving the image data corresponding to the foregoing address from the data server; and an image data generating means (for example, the recovering device side image embedding means 36) for generating the image data of the image having the hidden image included within the concealment image thereof by employing the image data received by the data requesting means and the image data of the concealment image.

The information recovering device may be configured so that it includes an image expanding means for expanding the compressed data to the before-compression data, the image expanding means expands the image data received from the data server to the before-compression image data, and the image data generating means generates the image data of the image having the hidden image included within the concealment image thereof by employing the expanded image data and the image data of the concealment image.

The information recovering device may be configured so that it includes a deciphering means for decrypting the encrypted data, the deciphering means decrypts the image data received from the data server, and the image data generating means generates the image data of the image having the hidden image included within the concealment image thereof by employing the decrypted image data and the image data of the concealment image.

The information recovering device may be configured so that it includes a deciphering means for decrypting the encrypted data, and an image expanding means for expanding the compressed data to the before-compression data, the deciphering means decrypts the image data received from the data server, the image expanding means expands the decrypted image data to the before-compression image data, and the image data generating means generates the image data of the image having the hidden image included within the concealment image thereof by employing the expanded image data and the image data of the concealment image.

The information recovering device may be configured so that the decoding means decodes two kinds of codes, i.e. a first code obtained by coding an address, and a second code obtained by coding image data, the data requesting means transmits the address decoded from the first code to the data server, and receives the image data corresponding to the foregoing address from the data server, the deciphering means decrypts both of the image data received from the data server and the image data decoded from the second code, the image expanding means expands each of the decrypted two kinds of pieces of the image data to the before-compression image data, and the image data generating means generates the image data of the image having the hidden image included within the concealment image thereof by employing the image data obtained by decrypting and expanding the image data decoded from the second code, and the image data of the concealment image, and generates the image data of the image having the hidden image included within the concealment image thereof by employing the image data obtained by decrypting and expanding the image data received from the data server and the image data of the concealment image.

The information concealing method of the present invention is characterized in that: a masking means urges a user to designate a region, which should be concealed, in an input image, being an image that has been inputted; a concealment region specifying means generates image data that expresses the image of the region designated in the input image, and expresses the region other than the designated region in a single color; a coding means converts the image data, which expresses the image of the region designated in the input image, and expresses the region other than the designated region in a single color, into the image data expressing a code; and an embedding means generates the image data of the image that expresses the region designated in the input image in a single color, and embeds the code into the foregoing image.

The information concealing method of the present invention is characterized in that: a masking means urges a user to designate a region, which should be concealed, in an input image, being an image that has been inputted; a concealment region specifying means generates image data that expresses the image of the region designated in the input image, and expresses the region other than the designated region in a single color; a data storage instructing means transmits image data, which expresses the image of the region designated in the input image, and expresses the region other than the designated region in a single color, to a data server, and causes the data server to store it; a coding means converts an address of the image data stored to the data server into image data expressing a code; and an embedding means generates the image data of the image that expresses the region designated in the input image in a single color, and embeds the code into the foregoing image.

The information recovering method of the present invention is characterized in that: a decoding means decodes the code within a concealment image including the code, of which one part has been hidden, to before-coding data; and an image data generating means (for example, the recovering device side image embedding means 36) generates image data of the image having the hidden image included within the concealment image thereof by employing the decoded data and the image data of the concealment image.

The information recovering method of the present invention is characterized in that: a decoding means decodes a code within a concealment image including the code, of which one part has been hidden, to a before-coding address; a data requesting means transmits the foregoing address to a data server and receives image data corresponding to the foregoing address from the data server; and an image data generating means (for example, the recovering device side image embedding means 36) generates the image data of the image having the hidden image included within the concealment image thereof by employing the image data received by the data requesting means and the image data of the concealment image.

The information concealing program of the present invention is characterized in causing a computer to execute: a masking process of urging a user to designate a region, which should be concealed, in an input image, being an image that has been inputted; a concealment region specifying process of generating image data that expresses the image of the region designated in the input image, and expresses the region other than the designated region in a single color; an coding process of converting the image data, which expresses the image of the region designated in the input image, and expresses the region other than the designated region in a single color, into image data expressing a code; and an embedding process of generating the image data of the image that expresses the region designated in the input image in a single color, and embedding the code into the foregoing image.

The information concealing program of the present invention is characterized in causing a computer to execute: a masking process of urging a user to designate a region, which should be concealed, in an input image, being an image that has been inputted; a concealment region specifying process of generating image data that expresses the image of the region designated in the input image, and expresses the region other than the designated region in a single color; a data storage instructing process of transmitting the image data, which expresses the image of the region designated in the input image, and expresses the region other than the designated region in a single color, to a data server, and causing the data server to store it; a coding process of converting an address of the image data stored to the data server into image data expressing a code; and an embedding process of generating the image data of the image that expresses the region designated in the input image in a single color, and embedding the code into the foregoing image.

Further, the information recovering program of the present invention is characterized in causing a computer to execute: a decoding process of decoding a code within a concealment image including the code, of which one part has been hidden, to before-coding data; and an image data generating process of generating the image data of the image having the hidden image included within the concealment image thereof by employing the decoded data and the image data of the concealment image.

Further, the information recovering program of the present invention is characterized in causing a computer to execute: a decoding process of decoding a code within a concealment image including the code, of which one part has been hidden, to a before-coding address; a data requesting process of transmitting the foregoing address to a data server and receiving the image data corresponding to the foregoing address from the data server; and an image data generating process of generating the image data of the image having the hidden image included within the concealment image hereof by employing the image data received in the data requesting process and the image data of the concealment image.

Hereinafter, specific embodiments of the present invention will be explained by making a reference to the accompanied drawings.

### Embodiment 1

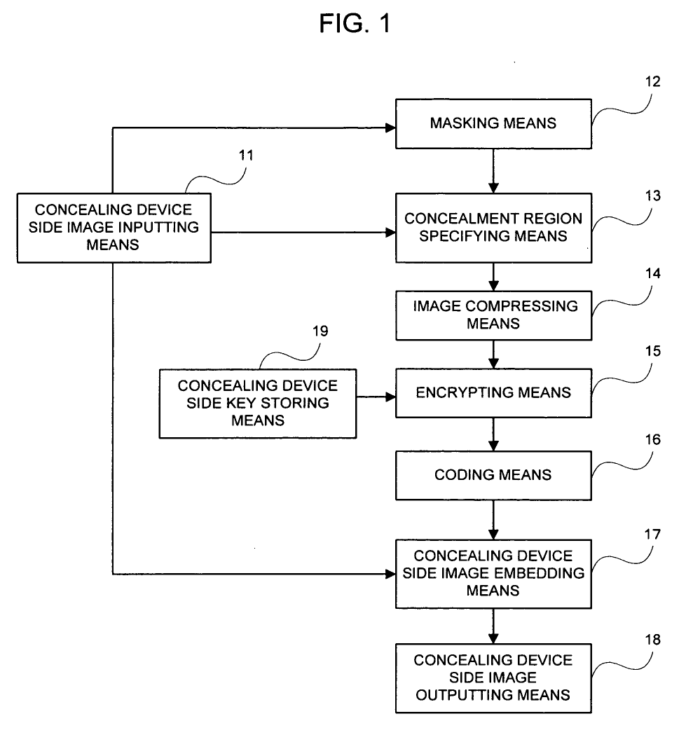

FIG. 1 is a block diagram illustrating an example of the information concealing device of the first embodiment. As shown in FIG. 1, the information concealing device of the first embodiment includes a concealing device side image inputting means (hereinafter, referred to as a first inputting means) 11, a masking means 12, a concealment region specifying means 13, an image compressing means 14, an encrypting means 15, a coding means 16, a concealing device side image embedding means (hereinafter, referred to as a first embedding means) 17, a concealing device side image outputting means (hereinafter, referred to as a first outputting means) 18, and a concealing device side key storing means (hereinafter, referred to as a first key storing means) 19.

The first inputting means 11 is an input device for inputting the image. The aspect of the first inputting means 11 is not limited particularly. The first inputting means 11 may be realized with a camera, a scanner, or the like when it inputs the printed image. In this case, the first inputting means 11 converts the inputted image into electronic data. Further, the first inputting means 11 could be a device for inputting the electronic data in the case that the image has already been converted into the electronic data. For example, the first inputting means 11 may be realized with a reading-off device for reading off the image (the electronic data) stored in a record medium. Additionally, this is an exemplification of the first inputting means 11, and the aspect of the first inputting means 11 is not limited particularly. Hereinafter, the image inputted by the first inputting means 11 is referred to as an input image. The data expressing the input image is referred to as input image data.

The masking means 12 urges a person who conceals the image (hereinafter, referred to as a concealing side user) to designate the region being concealed. The masking means 12 is realized, for example, with a display device for displaying the image, a pointing device such as a mouse, and an arithmetic processing unit (for example, CPU) for recognizing the region designated by the pointing device. For example, the masking means 12 displays the input image together with a message for urging designation of the region on the display device. And, when the region of one part of the displayed input image is designated by the pointing device that the concealing side user manipulates, the masking means 12 generates image data (hereinafter, referred to as mask data) that distinguishes the designated region from the region other than it, being image data expressing the image of which the pixel number is identical to that of the input image. Specifically, the masking means 12 generates the mask data in which “1” has been allotted to the data of the designated region, and “0” has been allotted to the data of the region other than it, being image data of the image of which the pixel number is identical to that of the input image. Additionally, the concealing side user designates the region, which should be concealed, within the input image. Thus, the designated region signifies the region that should be concealed. Further, the masking means 12 automatically may generate the mask data from a pre-instructed character string that should be concealed. In this case, the masking means 12 finds out the character string that should be concealed from the image with the technique such as a pattern matching, and defines the found-out region (i.e. the region in which the detected character string exits) as a concealment region. When the masking means 12 automatically generates the mask data, it is realized, for example, with the CPU. Additionally, this is an exemplification of the masking means 12, and the aspect of the masking means 12 is not limited particularly.

The concealment region specifying means 13 generates the image data, which expresses only the designated region within the input images, and expresses the region other than the designated region in a single color, from the input image data and the mask data. That is, the concealment region specifying means 13 generates the image data, which expresses only the image of the region, which should be concealed, within the input image, and expresses the region other than it in a single color.

The image compressing means 14 compresses the data generated by the concealment region specifying means 13.

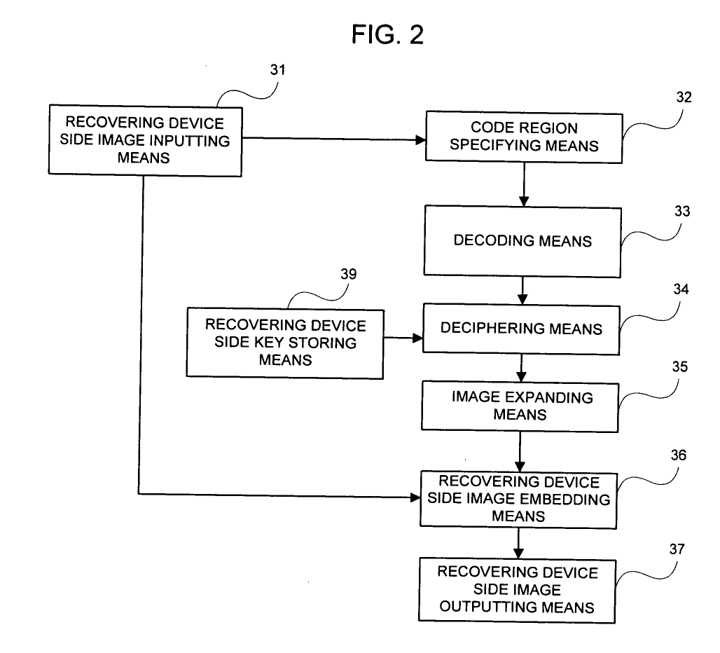

The encrypting means 15 encrypts the data compressed by the image compressing means 14. The first key storing means 19 is a storing device for storing a key that is employed for encryption. The encrypting means 15 encrypts the compressed data by employing the key stored in the first key storing means 19. Additionally, the encrypting technique could be a common key encrypting technique or a public key encrypting technique. With the case of the common key encrypting technique, the first key storing means 19 and a recovering device side key storing means 39 (see FIG. 2) store a common key. Further, with the case of the public key encrypting technique, the first key storing means 19 stores the public key, and the recovering device side key storing means 39 (see FIG. 2) stores a secret key.

The coding means 16 converts the data encrypted by the encrypting means 15 into the image data expressing a code. Herein, while the code could be a one-dimensional code such a barcode, and could be a two-dimensional code such a QR code, the encrypted data is preferably converted into the image data of the two-dimensional code that can accommodate much more information. Hereinafter, the case that the coding means 16 converts the encrypted data into the image data expressing the two-dimensional code is exemplified for explanation. Further, with the position and the size of the code at the time of having embedded the code into the image defined to be a reference, the coding means 16 converts information as well (hereinafter, referred to as a position-aligning information) indicative of the position and the size of the image having the code embedded herein, together with the encrypted data, into the image data expressing the code. In addition hereto, at this time, the coding means 16 codes the mask data as well generated by the masking means 12 in all. That is, the coding means 16 converts the encrypted data, the position-aligning information, and the mask data in all into the image data expressing the code.

The first embedding means 17 hides the designated region (i.e. the encrypted region) within the input image, and generates the image data indicative of the image having the two-dimensional code embedded therein.

The first outputting means 18 hides the designated region (the encrypted region) within the input image based upon the image data generated by the first embedding means 17, and outputs the image having the two-dimensional code embedded therein. The first outputting means 18 could be, for example, a display device for displaying the image. Further, the first outputting means 18 could be a printing device for printing the image.

The masking means 12, the concealment region specifying means 13, the image compressing means 14, the encrypting means 15, and the coding means 16, and the first embedding means 17 may be realized, for example, with the CPU that operates according to a program (information concealing program), and each of these means may be realized with the identical CPU. Additionally, the information concealing program is pre-stored in a storage device that the information concealing device includes, and the CPU reads off the information concealing program and operates according hereto.

The information recovering device of the present invention, which is a device for generating and outputting the original image from the image into which the code (in this example, the two-dimensional code) has been embedded by the information concealing device, is preferably a device capable of outputting the information in the vicinity of the information reader, for example, a mobile terminal device.

FIG. 2 is a block diagram illustrating an example of the information recovering device of the first embodiment. The information recovering device of the first embodiment includes a recovering device side image inputting means (hereinafter, referred to as a second inputting means) 31, a code region specifying means 32, a decoding means 33, a deciphering means 34, an image expanding means 35, a recovering device side image embedding means (hereinafter, referred to as a second embedding means) 36, a recovering device side image outputting means (hereinafter, referred to as a second outputting means) 37, and a recovering device side key storing means (hereinafter, referred to as a second key storing means) 39.

The second inputting means 31 is an input device for inputting the image. The aspect of the second inputting means 31 is not limited particularly. The second inputting means 31 is realized with a camera, a scanner, or the like when it inputs the information printed on the printing material as an image. Further, the second inputting means 31 is realized, for example, with a camera when it inputs the image displayed on the other display devices. With the case of a form in which the image data being inputted into the other display devices branches off just before an image data input terminal of the above display device, and the image data of the image being displayed on the above display device is supplied directly to the information recovering device as well, the image data input terminal of the information recovering device becomes the second inputting means 31. The image inputted by the second inputting means 31 is referred to as a concealment image, and the image data expressing the above concealment image is referred to as concealment image data.

The code region specifying means 32 specifies the region in the concealment image having the two-dimensional code embedded therein.

The decoding means 33 decodes the two-dimensional code existing in the region specified by the code region specifying means 32. Herein, “the so-called decoding” signifies that the image data expressing the code is converted into before-coding information. The decoding means 33 decodes the two-dimensional code existing in the region specified by the code region specifying means 32, thereby to acquire the encrypted data, the position-aligning information, and the mask data.

Additionally, to recover the encrypted data to a before-encryption plain text is referred to as “decryption (or decipher)”, which is differentiated from the above-mentioned “decoding” of the code.

The deciphering means 34 decrypts the encrypted data acquired in a decoding process performed by the decoding means 33. That is, the deciphering means 34 returns the encrypted data to the before-encryption plain text. The second key storing means 39 is a storage device for storing a key that is employed for decryption. The deciphering means 34 decrypts the encrypted data by employing the key stored in the second key storing means 39.

The data decrypted by the deciphering means 34 is compressed data. The image expanding means 35 expands the above data. That is, the image expanding means 35 returns the compressed data into a before-compression status. The expanded data is image data that expresses only the image of the region concealed by the information concealing device, and expresses the region other than it in a single color.

The second embedding means 36 makes a reference to the mask data acquired with the decoding, and from the image data (expanded image data) of the image, which expresses only the image of the concealed region, and expresses the region other than it in a single color, and the concealment image data, generates the image data of the image having the image of the above concealed region included in the concealment image thereof. Specifically, the second embedding means 36 specifies the region within the inputted concealment image, which the position-aligning information indicates. Further, the second embedding means 36 makes a reference to each pixel of the mask data, and determines whether each pixel expresses the designated region or the region other than it. In the case that the pixel of the mask data expresses the designated region, the second embedding means 36 takes out the data of the pixel of the image corresponding to the pixel of the above mask data, which expresses only the image of the concealed region, and expresses the region other than it in a single color, from the above image data. Further, in the case that the pixel of the mask data expresses the region other than it, the second embedding means 36 takes out the data of the pixel of the region within the concealment image corresponding to the pixel of the above mask data, which the position-aligning information indicates, from the concealment image data. The second embedding means 36 generates the image data by putting the data of each pixel side by side to a line of each pixel. As a result, the image data expressing an image similar to the image that has not been concealed by the information concealing device is generated.

The second outputting means 37 outputs the image (image similar to the before-concealment image) based upon the image data generated by the second embedding means 36. The second outputting means 37 could be, for example, a display device for displaying the image. Further, the second outputting means 37 could be a printing device for printing the image. Further, as already explained, it is preferable that the information recovering device is a device capable of outputting the information in the vicinity of the information reader. When the information recovering device is a mobile terminal, the second outputting means 37 is realized with the display device that the mobile terminal includes. Further, when the information recovering device is a head mount display provided with a camera capable of photographing the image displayed on the other display devices, the second outputting means 37 is realized with the display part that the above head mount display includes. When the information recovering device is a head mount display device to which the image data branching off just before the input terminal of the other display device is supplied, the situation is similar.

The code region specifying means 32, the decoding means 33, the deciphering means 34, the image expanding means 35, and the second embedding means 36 may be realized, for example, with the CPU that operates according to a program (information recovering program), and each of these means may be realized with the identical CPU. Additionally, the information recovering program is pre-stored in a storage device that the information recovering device includes, and the CPU reads off the information recovering program and operates according hereto.

Next, an operation will be explained.

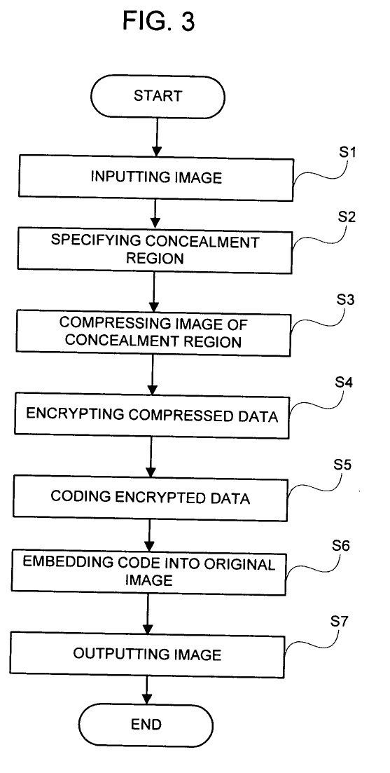

FIG. 3 is a flowchart illustrating an example of a processing flow of the information concealing device of the present invention. The first inputting means 11 inputs the image (step S1). When the first inputting means 11 is a camera, it inputs the image by photographing it, and defines the image to be image data (electronic data). When the first inputting means 11 is a scanner, it inputs the image by loading it, and defines the image to be image data. Additionally, the aspect in which the first inputting means 11 inputs the image is not limited to the above-mentioned example. The first inputting means 11 may input the image data already converted into electronic data.

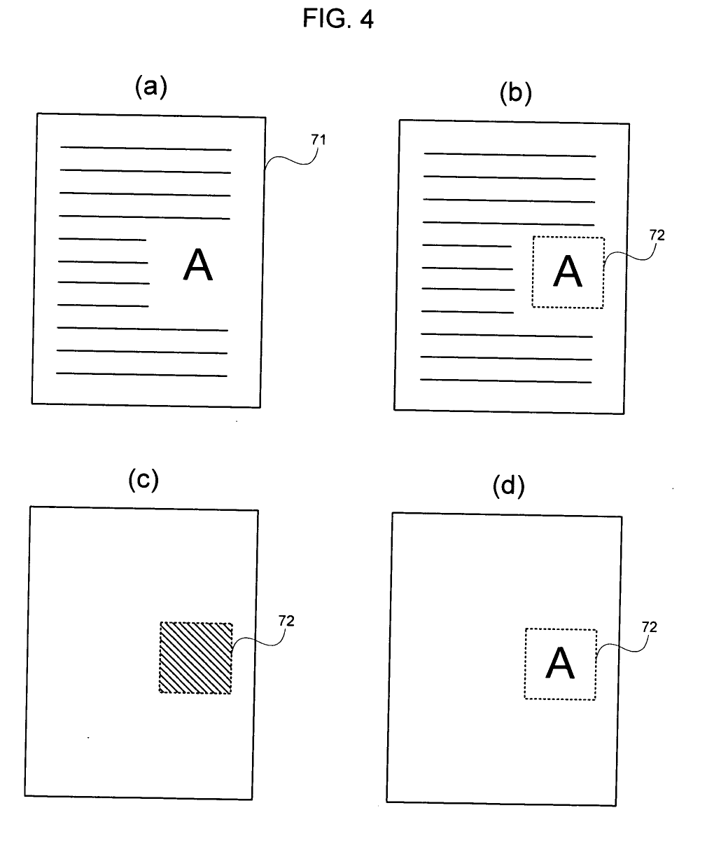

Continuously, the information concealing device specifies the concealment region (step S2). FIG. 4 is an explanatory view schematically illustrating an operation of the step S2. In the step S2, the masking means 12 firstly displays the input image on the display device. At this time, the masking means 12 may display a message as well for urging designation of the region on the display device. Additionally, it is assumed that the masking means 12 is realized, for example, with the display device, the pointing device, and the CPU for recognizing the region designated by the pointing device.

After the input image is displayed, the concealing side user manipulates the pointing device, and designates the region that should be concealed. Then, the masking means 12 generates the mask data for distinguishing the designated region from the region other than it, being image data expressing the image of which the pixel number is identical to that of the input image.

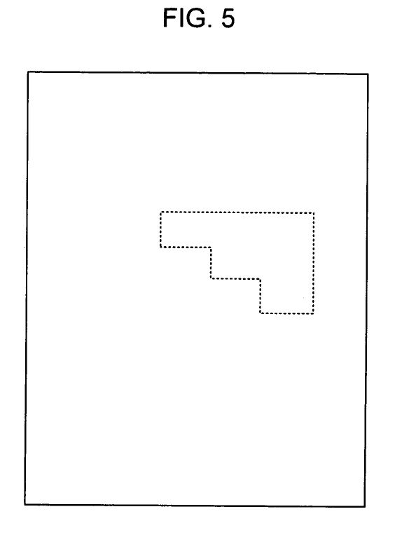

For example, when the input image is an image 71 exemplified in FIG. 4(a), the masking means 12 displays the above input image 71. And, it is assumed that a region 72 (see FIG. 4 (b)) within the input image 71, which should be concealed, has been designated. Additionally, in FIG. 4(b), the case that the region 72 was designated as a rectangular region was exemplified; however the shape of the region that should be concealed is designated by the concealing side user, and is not limited to a rectangle, and an arbitrary shape is acceptable. For example, the shape exemplified in FIG. 5 is acceptable. Further, the position and the size of the region 72 are also designated by the concealing side user.

When the region 72 that should be concealed is designated, the masking means 12 generates the mask data for distinguishing the designated region 72 from the region other than it, being image data expressing the image of which the pixel number is identical to that of the input image. FIG. 4(c) shows an example of the image that the mask data expresses. The masking means 12 allots only “1” to the image data of the designated region 72, and only “0” to the image data of the region other than it, thereby to distinguish the designated region 72 from the region other than it. The masking means 12 allots “1” to the data of each pixel belonging to the region 72, and “0” to the data of each pixel belonging to the region other than the region 72. The mask data is binary data of “0” and “1”.

After the masking means 12 generates the mask data, the concealment region specifying means 13 generates the image data, which expresses only the designated region within the input image, and expresses the region other than it in a single color, by calculating a logical product of the input image and the mask data. For example, the concealment region specifying means 13 generates the image data, which expresses the image exemplified in FIG. 4(d). The image shown in FIG. 4(d) is an image in which only the image of the region 72 within the input image survives, and the region other than the region 72 is expressed in a single color. The so-called calculation of a logical product of the input image data and the mask data is to calculate a logical product of the data of the pixel being included in the input image data and the data of the pixel being included in the mask data for each corresponding pixel. With the above-mention logical product, the image data of the image in which only the region 72 within the input image survives can be acquired because “1” is allotted to the data of each pixel belonging to the region 72, and “0” is allotted to the data of each pixel belonging to the region other than it in the mask data. Above, a process of the step S2 is finished.

After the step S2, the image compressing means 14 compresses the image data (the image data which expresses only the designated region within the input image, and expresses the region other than it in a single color) generated by the concealment region specifying means 13. For example, the image compressing means 14 compresses the image data of the image exemplified in FIG. 4(d) (step S3). The aspect of the compression by the image compressing means 14 is not limited particularly.

The image compressing means 14 may compress the image data by converting the image data including the by-pixel data into the image data including the number of the continuous pixels having an identical color (run length).

Or, the image compressing means 14 may compress the image data by curtailing the bit length expressing the color, which is often employed.

Further, the image compressing means 14 may compress the image data with the compression techniques such as JPEG, JPEG-2000, PNG, GIF, etc.

Compressing the data in which the region other than the designated region is expressed in a single color in the step S3 makes it possible to enhance a compression ratio of the data all the more as compared with the case of the inputted original image data. That is, employing the appropriate compression technique enables the mask data having an arbitrary shape to be efficiently image-compressed.

After the step S3, the encrypting means 15 loads the key from the first key storing means 19, and encrypts the compressed data by employing the above key (step S4). Additionally, the configuration in which the first key storing means 19 is located outside the information concealing device, and the key information is transmitted to the information concealing device with the communication means for preventing the key information from being tapped by the other persons may be employed.

The encrypting technique could be a common key encrypting technique or a public key encrypting technique. When the information concealing device and the information recovering device adopt a common key encrypting technique, the first key storing means 19 and the second key storing means 39 store a common key, respectively. The encrypting means 15 reads out the common key from the first key storing means 19, and encrypts the data by employing the above common key. Further, when the information concealing device and the information recovering device adopt a public key encrypting technique, the first key storing means 19 stores a public key, and the second key storing means 39 stores a secret key. The encrypting means 15 reads out the public key from the first key storing means 19, and encrypts the data by employing the above public key.

Further, an algorithm with which the encrypting means 15 encrypts the data is not limited particularly. For example, there exist AES and DES as an encrypting algorithm of the common key encrypting technique, and there exist RSA and an elliptic curve cryptosystem as an encrypting algorithm of the public key encrypting technique. The encrypting means 15 may encrypt the data with these exemplified algorithms. Or, it may encrypt the data with algorithms other than these algorithms.

After the step S4, the coding means 16 converts the encrypted data, the position-aligning information, and the mask data in all into the image data expressing the code (in this example, the two-dimensional code) (step S5).

In the step S5, the coding means 16 decides the position in the input image, into which the two-dimensional code is embedded (namely, the position in which the two-dimensional code is arranged). The coding means 16 decides the arrangement position of the two-dimensional code, for example, so that the two-dimensional code is accommodated within the region of the image designated in the step S2, which should be concealed (for example, the region 72 exemplified in FIG. 4). When the two-dimensional code is not accommodated within the designated region, the coding means 16 decides the arrangement position of the two-dimensional code so that the two-dimensional code is accommodated within a blank region, out of image. Additionally, when the region of which the pixel number is more than a threshold of the image periphery of the input image has an identical color, the coding means 16 determines the above region to be a blank region.

Further, when the coding means 16 has determined that no blank region exists, it may decide that the two-dimensional code is arranged in the region of the image designated in the step 2, which should be concealed. In this case, it does not matter that, in a step S6 to be later described, the two-dimensional code is not accommodated in the designated region, and is crowded out, and as a result, the two-dimensional code is over-written upon information of the circumference of the designated region.

Further, when the coding means 16 has determined that no blank region exists, it may generate the image data obtained by adding the blank region to the circumference of the input image, and may decide the above blank region to be an arrangement position of the two-dimensional code. In this case, adding the similar blank region to the mask data generated by the masking means 12 and the image data generated by the concealment region specifying means 13 as well causes the pixel number of them to coincide with that of the image data obtained by adding the blank region to the circumference of the input image.

Further, the concealing side user may designate the arrangement position of the two-dimensional code with the pointing device. That is, the coding means 16 may designate the arrangement position of the two-dimensional code as follows. The coding means 16 causes the display device to display the input image. When the user designates the position within the displayed input image by employing the pointing device, the coding means 16 decides the above designated position to be an arrangement position of the two-dimensional code.

When the coding means 16 decides the arrangement position of the two-dimensional code, it generates the position-aligning information indicative of the position and the size of the image into which the code is embedded with the above arrangement position defined to be a reference. The image into which the code is embedded is an image, in which the region other than the region 72 within the input image survives, and the image within the region 72 is expressed only in a single color, and the image data of this image is generated in a step S6, which is later described. Further, the size and the pixel number of this image are identical to the size and the pixel number of the input image, respectively. The coding means 16 obtains the range of the input image in the case of having arranged the code in the input image with the arrangement position of the code defined to be a reference. For example, the coding means 16 computes the coordinate indicative of the range of the input image in the case of having arranged the code with a width of the two-dimensional code and a height of the two-dimensional code defined to be “a” and “b”, respectively, with the pre-determined position of the two-dimensional code (for example, one of the corners of the two-dimensional code) defined to be an origin, and with the width “a” of the two-dimensional code and the height “b” of the two-dimensional code defined to be a unit of an x coordinate and a unit of a y coordinate, respectively. And, the coding means 16 defines the above coordinate to be position-aligning information.

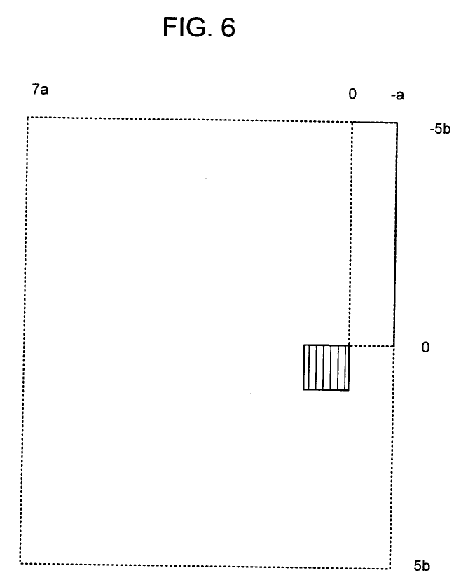

FIG. 6 is an explanatory view illustrating an example of generating the position-aligning information. The region with longitudinal lines shown in FIG. 6 is an arrangement position of the two-dimensional code. Further, the explanation is made on the assumption that, in FIG. 6, a corner in an upper right of the two-dimensional code is an origin, the turning-left direction is a positive direction of an x axis, and the turning-down direction is a positive direction of a y axis. Further, FIG. 6 shows an example of the case of arranging the code in the region located in a right side of the center of the input image to some extent. The coding means 16 specifies the range of the input image in the case of having arranged the code with the arrangement position of the two-dimensional code (more specifically, a corner of the two-dimensional code defined to be a origin) defined to be a reference, and with the width “a” and the height “b” of the two-dimensional code defined to be a length, being a unit of an x coordinate and a unit of a y coordinate, respectively. In an example shown in FIG. 6, the coding means 16 specifies the range of −a to 7a as an x coordinate, and the range of −5b to 5b as a y coordinate. This range becomes position-aligning information.

The coding means 16, after obtaining the position-aligning information, generates the image data expressing the two-dimensional code, which includes the above position-aligning information, the information encrypted in the step S4, and the mask data. Specifically, the coding means 16 generates the image data expressing the two-dimensional code in which the position-aligning information, the encrypted data, and the mask data have been arranged in a predetermined position.

For example, it is assumed that the two-dimensional code is a QR code. In the QR code, a finder pattern (three position-detection patterns being arranged in three corners), an alignment pattern (pattern for correcting position discrepancy of each cell (dot) that occurs due to stress), a quiet zone (a blank part around the two-dimensional code), a timing pattern (a pattern for deciding a module coordinate within the two-dimensional code), and a position arrangement of format information haven been decided. In addition hereto, a data arrangement position and an arrangement position of the error correction code of the data have been also decided. For example, the coding means 16 generates the image data of the QR code in which the position-aligning information, the encrypted data, and the mask data have been arranged in the data arrangement position, the position-aligning information, the encrypted data, and the error correction code of the mask data have been arranged in the arrangement position thereof, and further, the finder pattern, the alignment pattern, the quiet zone, the timing pattern, and the format information have been arranged in respective predetermined positions.

Herein, the case of the QR code was exemplified for explanation; however, also in the case of other two-dimensional codes, the coding means 16 generates the image data expressing the two-dimensional code in which the position-aligning information, the encrypted data, and the mask data have been arranged in a predetermined position.

Additionally, the size of the two-dimensional code could be a predetermined size, and could be a minimum size for enabling the position-aligning information, the encrypted data and the mask data to be accommodated. Further, when the size of the two-dimensional code is identical, the smaller the cell (dot) within the two-dimensional code is, the much the data that can be accommodated within the two-dimensional code is, and the larger the cell is, the fewer the data that can be accommodated within the two-dimensional code is. In the case that the size of the two-dimensional code has been pre-decided, the size of the cell that enables the position-aligning information, the encrypted data, and the mask data to be accommodated is decided. When the position-aligning information, the encrypted data and the mask data cannot be accommodated within the two-dimensional code even though the cell is made small, the resolution of the image data generated by the concealment region specifying means 13 is firstly lowered, and thereafter the above image data is subjected to the compression of the step S3 and the encryption of the step S4. So as to lower the resolution, plural pixels by plural pixels, the above plural pixels are replaced with one pixel by averaging them or the like.

After the step S5, the first embedding means 17 hides the designated region (i.e. the encrypted region) within the input image, and generates the image data indicative of the image into which the two-dimensional code has been embedded (step S6).

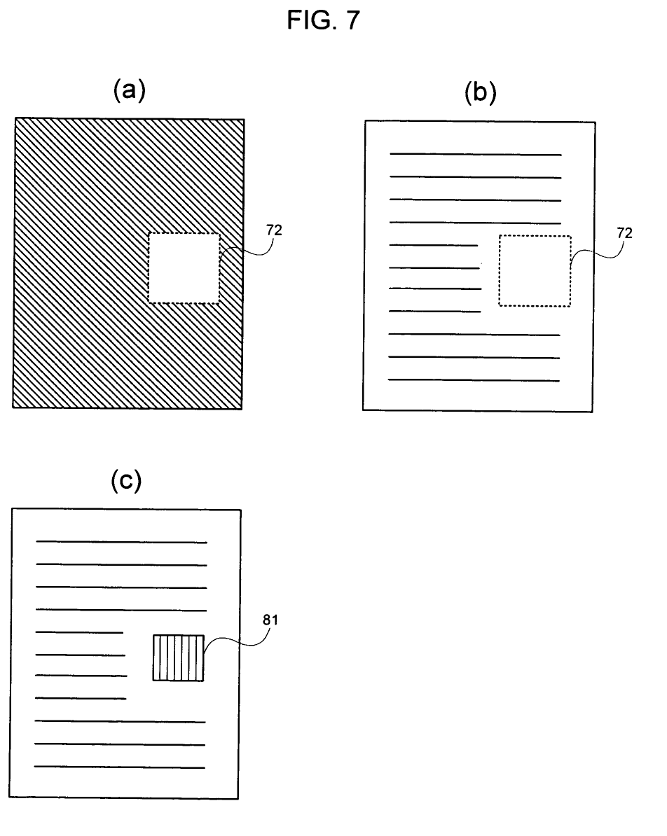

The first embedding means 17 firstly generates inverted data of the mask data in the step S6. The so-called inverted data of the mask data is data obtained by inverting “0” and “1” of the mask data, being binary data. Thus, in the inverted data of the mask data, “0” is allotted to the data of each pixel belonging to the region 72, and “1” is allotted to the data of each pixel belonging to the region other than the region 72. FIG. 7(a) shows an example of the image that the inverted data of the mask data indicates.

Continuously, the first embedding means 17 generates the image data of the image having the designated region hidden therein by calculating a logical product of the input image data (the image data of the input image exemplified in FIG. 4(a)) and the inverted data of the mask data. The first embedding means 17 generates, for example, the image data expressing the image exemplified in FIG. 7(b). The so-called calculation of this logical product is to calculate a logical product of the data of the pixel being included in the input image data, and the data of the pixel being included in the inverted data of the mask data for each corresponding pixel. In the inverted data of the mask data, “0” is allotted to the data of each pixel belonging to the region 72, and “1” is allotted to the data of each pixel belonging to the region other than it. Thus, with the above-mention logical product, the image data of the image in which the region other than the region 72 within the input image survives, and the image within the region 72 is expressed in a single color is acquired.

In addition hereto, the first embedding means 17 superposes the two-dimensional code upon the above image data. That is, the first embedding means 17 superposes the image data expressing the two-dimensional code generated in the step S5 upon the image data that is acquired as a logical product of the inverted data of the mask data and the input image data. At this time, the first embedding means 17 superposes the image data expressing the two-dimensional code upon the image data being acquired as a logical product of the inverted data of the mask data and the input image data so that the two-dimensional code is arranged in the arrangement position decided in the step S5. More specifically, the first embedding means 17 replaces the image data equivalent to the code arrangement region in the image data being acquired as a logical product of the inverted data of the mask data and the input image data with the image data expressing the code (in this example, the two-dimensional code). Above, a process of the step S6 is completed. The image data acquired as a result, as exemplified in FIG. 7(c), expresses the image, which has the information of the designated region 72 hidden therein, and includes the two-dimensional code.

After the step S6, the first outputting means 18 outputs the image based upon the image data generated in the step S6 (step S7). This output aspect could be an aspect of the display output, and could be an aspect of the printing output. The first outputting means 18 outputs, for example, the image exemplified in FIG. 7(c).

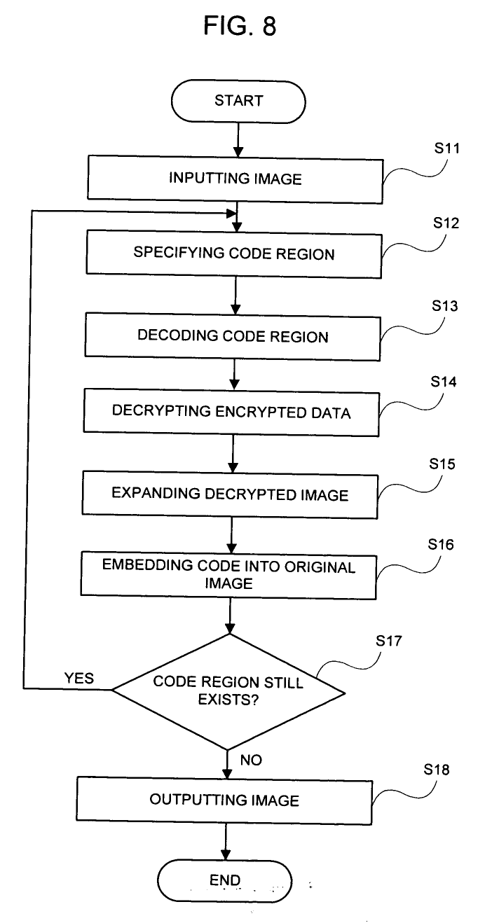

FIG. 8 is a flowchart illustrating an example of a processing flow of the information recovering device of the present invention. The second inputting means 31 inputs the image, which has information of one part of the region (the region designated by the concealing side user) hidden therein and includes a two-dimensional code 81 (see FIG. 7(c)) (step S11). When the second inputting means 31 is a camera, it inputs the image by photographing it, and defines the image to be image data (electronic data). Further, when the second inputting means 31 is a scanner, it inputs the image by loading it, and defines the image to be image data. The second inputting means 31 may input the image data already converted into electronic data. In the following, the case that the information recovering device is a mobile terminal, and is provided with a camera as the second inputting means 31 is exemplified for explanation.

Next, the code region specifying means 32 specifies the region in which the code (in this example, the two-dimensional code) has been arranged from the region of the inputted image (concealment image) (step S12). The two-dimensional code includes a maker indicative of the region of the code (for example, the finder pattern in the QR code), whereby the code region specifying means 32 specifies the region being specified with the above marker as an arrangement region of the code. When the markers have been installed in three locations of one two-dimensional code, the code region specifying means 32 can specify the arrangement region of the two-dimensional code also in the case that the camera (the second inputting means 31) photographs the image, being a target of the photographing, in an oblique direction.

Next, the decoding means 33 decodes the two-dimensional code existing in the region specified by the code region specifying means 32 (step S13). The decoding means 33 extracts the data corresponding to the data arrangement position in the two-dimensional code from the concealment image data. The decoded data includes the data encrypted by the encrypting means 15 of the information concealing device, the position-aligning information, and the mask data.

After the step S13, the deciphering means 34 loads the key from the second key storing means 34, and decrypts the encrypted data included in the data decoded in the step S13 by employing the above key (step S14). This decrypting process is a process of decrypting the data encrypted in the encrypting process by the encrypting means 15 of the information concealing device, and the deciphering means 34 decrypts the data with a common key common to the key employed for the encryption, or a secret key that corresponds to the public key employed for the encryption. Further, as an algorithm with which the deciphering means 34 decrypts the encrypted data, the algorithm, which forms a counterpart to the encrypting algorithm, is acceptable, and the algorithm is not limited particularly. Additionally, the configuration in which the second key storing means 39 is located outside the information concealing device, and the key information is transmitted to the information concealing device with the communication means for preventing the key information from being tapped by the other persons may be employed.

After the step S14, the image expanding means 35 expands the data decrypted in the step S14 (step S15). This is, the image expanding means 35 returns the compressed data into a before-compression status. The image expanding means 35 expands the data in such an aspect that the above expansion forms a counterpart to the compression by the image compressing means 14 of the information concealing device, and the aspect of the expansion is not limited particularly.

For example, the image expanding means 35 may expand the image data by converting the image data including the run length into the image data including by-pixel data.

Further, the image expanding means 35 may expand the image data by returning the curtailed bit length to the original bit length when the information concealing device for compressing the image data by curtailing the bit length expressing the color that is often employed, and the information recovering device form a counterpart to each other.

Further, when the information concealing device for compressing the image data with compressing techniques such as the JPEG, the JPEG-2000, the PNG, and the GIF, and the information recovering device form a counterpart to each other, the image expanding means 35 expands the image data with the expanding technique that corresponds to the compressing technique of these items of the image data.

The second embedding means 36 performs a process of superposing the concealed image upon the inputted image. However, this superposing process differs from the superposing process being performed by the information concealing device (step S6). The second embedding means 36 makes a reference to the mask data acquired in the decoding process of the step S13, and employs the expanded image data and the concealment image data, thereby to generate the image data of the image having the image of the concealed region included in the concealment image thereof (step S16). The expanded image data is image data of the image, which expresses only the image of the concealed region, and expresses the region other than it in a single color, as shown in FIG. 4(d).

In the step S16, the second embedding means 36 specifies the region within the concealment image inputted in the step S11, which the position-aligning information indicates. In the case that the code has been photographed in a small photographing size because the image, being a subject, and the camera (second inputting means 31) are away from each other, the region that the position-aligning information indicates in the photographed image becomes small because the position-aligning information is information with the position and the size of the code defined to be a reference. Further, in the case that the code has been photographed in a large photographing size because the image, being a subject, and the camera (second inputting means 31) are close to each other, the region that the position-aligning information indicates in the photographed image becomes large.

The second embedding means 36 regulates the pixel number of the image of the region within the concealment image, which the position-aligning information indicates, to the pixel number identical to that of the expanded image data (the image data of the image that expresses only the image of the concealed region, and expresses the region other than it in a single color). So as to reduce the pixel number, the plural pixels are replaced with one pixel by averaging them or the like. So as to increase the pixel number, one pixel is replaced with plural pixels having the data common to the above pixel. Additionally, the pixel number of the expanded image data is identical to that of the mask data.

The second embedding means 36 makes a reference to each pixel of the mask data, and determines whether each pixel expresses the designated region or the region other than it. In the case that the pixel of the mask data expresses the designated region, the second embedding means 36 takes out the data of the pixel of the image corresponding to the pixel of the above mask data, which expresses only the image of the concealed region, and expresses the region other than it in a single color, from the above image data. On the other hand, in the case that the pixel of the mask data expresses the region other than it, the second embedding means 36 takes out the data of the pixel of the region within the concealment image corresponding to the pixel of the above mask data, which the position-aligning information indicates, from the concealment image data.

For example, it is assumed that the image of the region, which the position-aligning information indicates, in the inputted image is an image exemplified in FIG. 7(c). Further, it is assumed that the image, which the expanded image data indicates, is an image exemplified in FIG. 4(d), and the image, which the mask data indicates, is an image exemplified in FIG. 4(c). The second embedding means 36 takes out the pixel corresponding to the pixel, which exists out of the range of the region 72, in the mask data exemplified in FIG. 4(c) from the region (FIG. 7(c)) within the concealment image that the position-aligning information indicates. Further, the second embedding means 36 takes out the pixel, which corresponds to the pixel existing within the range of the region 72, in the mask data from the expanded image data (FIG. 4(d)). The second embedding means 36 generates the image data by putting the data of the taken-out each pixel side by side to a line of each pixel. This image data is image data expressing the image similar to the image (in this example, the image shown in FIG. 4(a)) that has not been concealed yet by the information concealing device. In such a manner above, the second embedding means 36 performs a process of superposing the concealed image upon the inputted image.

In such a manner, the second embedding means 36 specifies the region within the inputted concealment image, which the position-aligning information indicates, in the step S16. And, the second embedding means 36 employs the image data of the above region and the expanded image data, and generates the image data of the original image (the image exemplified in FIG. 4(a)) including the concealed image (the image of the region 72 exemplified in FIG. 4(d)), being image data of which the pixel number is identical to that of the expanded image data. Herein, the position-aligning information, as shown in FIG. 6, is information with the position and the size of the code defined to be a reference. When the code is inputted as a small image (in this example, the code is photographed in a small photographing size) because the image, being a subject, and the camera are away from each other, the range that the position-aligning information indicates becomes small. Further, when the code is inputted as a large image because the image, being a subject, and the camera are close to each other, the range that the position-aligning information indicates becomes large. As a result, the image data of the image having an appropriate size can be generated as image data of the image similar to the image that has not been concealed yet by the information concealing device.

When there exists the arrangement region of the two-dimensional code for which the process ranging from the step S12 to the step S16 has not been performed (NO of the step S17), the process of the step S12 and the steps subsequent hereto is repeated for each of the two-dimensional codes in theses arrangement regions. When the process ranging from the step S12 to the step S16 has been completed for each two-dimensional code (YES of the step S17), the second outputting means 37 outputs the original image (the before-concealment image) acquired by superposing the concealed image (step S18). The second outputting means 37 outputs the image, for example, by displaying it; however the second outputting means 37 may output the image by printing it.

In the foregoing, the case of the conversion to the two-dimensional code at the moment of the coding was exemplified; however the encrypted data may be converted into the image data expressing the one-dimensional code.

In the present invention, the original input image is acquired based upon the coded image when the image of the concealed region is embedded as a code (two-dimensional code or one-dimensional code) into the input image, and the concealed image is perused. The user of the information recovering device can peruse the concealed information also when the information concealing device and the information recovering device cannot transmit/receive the digital data to/from each other via the communication network because the image obtained by embedding the code into the input image is printable. Thus, the conventional restraint that each of the device on the sender side and the device on the receiver side needs to be communicable with the other can be alleviated. Further, only one part of the information is concealed, thereby enabling the status in which the third person cannot peruse the above one part of the information to be attained. Further, the person having recognized the image outputted by the information concealing device can recognize that the above image includes the concealed information due to existence of the code.

Further, when the information recovering device is a device that the person who peruses the image carries and uses in some cases, and wears and uses in some cases, for example, a mobile terminal and a head mount device, an anxiety that the decoded original image is viewed by the third person can be alleviated because eyes of the reader and the information recovering device are close to each other.

In the present invention, at the moment of the compression (step S3), the aspect of the compression that the image compressing means 14 carries out could be a resolution progressive compression. The so-called resolution progressive compression is a technique for allowing the images each having a different resolution to be taken out step by step. Specifically, the image compressing means 14 defines the image (for example, the image exemplified in FIG. 4(d)) acquired in the step S2 to be an image of which the resolution is highest, and generates the images having a lower resolution step by step. For example, the image compressing means 14 generates the images of which the resolution has been lowered to ½, ¼ or the like, respectively. The image compressing means 14 obtains the image having a lowest resolution, and a difference between each of the images having respective resolution levels and the other. And, the image compressing means 14 compresses the image having a lowest resolution, and compresses a difference between each of the images having respective resolution levels and the other.

For example, it is assumed that the before-compression image (which is defined to be an image A) expresses an image of a resolution 128×128, and the image compressing means 14 generates an image of a ½ resolution (64×64) (which is defined to be an image B) and an image of a ¼ resolution (32×32) (which is defined to be an image C), to begin with the above image, step by step. The image compressing means 14 obtains a difference between each of the images having respective resolutions and the other, namely, a difference between the image C and the image B, and a difference between the image B and the image A. The image compressing means 14 compresses the image C, and besides, compresses a difference between the image C and the image B, and a difference between the image B and the image A.

In the above-mentioned example, one technique of the resolution progressive compression techniques is shown, and the procedure of the compression does not matter particularly. There exists, for example, the JPEG-2000 format as a format of the image that can be subjected to the resolution progressive compression; however, in this format, the compression is carried out with the procedure different from the foregoing.

Also in the case that the image compressing means 14 has carried out the resolution progressive compression, the image expanding means 35 can carries out the expansion to the image data of the original image (the image having a highest resolution) from all of pieces of the compressed data in the step S15. However, the image expanding means 35 may carry out the expansion to the image data of the image having a low resolution. In the case of the above-mentioned example, the decoding to the image data of the image C having a low resolution may be carried out from the data obtained by compressing the image C. In this case, the image C of a ¼ resolution (32×32) is acquired, so it is used by enlarging the resolution thereof to a resolution 128×128. Further, the decoding to the image data of the image B may be carried out from the image C, and a difference between the image C and the image B. In this case, the image B of a ½ resolution (64×64) is acquired, so it is used by enlarging the resolution thereof to a resolution 128×128. Further, the decoding to the image data of the image A may carried out from the image C, a difference between the image C and the image B, and a difference between the image B and the image A. In this case, the image A of a resolution 128×128 is acquired. In such a manner, when the original image is acquired from the images subjected to the resolution progressive compression, the images having various resolutions ranging from the image having a low resolution to the image having a high resolution can be recovered.

Further, in the present invention, there is the case that when the encrypted data is large, the two-dimensional code as well has to be enlarged. When the size of the encrypted data is larger than a threshold, the masking means 12 may divide the region designated by the concealing side user into plural regions. And, the process ranging from the generation of the mask data to the step S6 is repeated for each region divided by the masking means 12. The masking means 12 may divide the designated region 72 into, for example, two regions. And, the process ranging from the generation of the mask data to the embedment into the input image of the step S6 may be performed for each of the two divided regions. In this case, it follows that the code (for example, the two-dimensional code) is generated for each region acquired by the division, and is embedded into the input image. Further, the information recovering device may perform the process ranging from the step S12 to the step S16 for each code when recovering this image. Performing the process ranging from the step S12 to the step S16 for one code makes one part of the designated region 72 readable, and performing the process ranging from the step S12 to the step S16 for all codes makes the entirety of the designated region 72 readable.

Further, in the present invention, after the encryption in the step S4, the coding means 16 (or the encrypting means 15) may divide the after-encryption data, and the coding means 16 may perform a process of the conversion into the image data expressing the code for each of plural pieces of the data acquired by the dividing. Also in this case, the information recovering device performs the process ranging from the step S12 to the step S16 for each code. However, in this example, the data being acquired by decoding one code is only one part of the after-encryption data. Thus, in this example, the code region specifying means 32 specifies the code region code by code (step S12), the decoding means 33 decodes the data code by code (step S13), and the decoding means 33 puts pieces of the data acquired by decoding respective codes side by side, and converts them into one piece of the data, thereby allowing the before-division data (encrypted data) to be recovered, and an operation of the step S14 and the steps subsequent hereto is performed for the above data.

Further, when the second inputting means 31 that the information recovering device of the present invention includes is a camera, there exists the case of photographing the image including the code in an oblique direction and photographing the image in a status of having been rotated as compared with the case of photographing the image in a front of it. Also in this case, when a marker (for example, three finder patterns in the QR code) indicative of the region of the code exists within the code, a parameter value indicative of the extent at which the image is rotated as against the camera, and the extent at which the image is obliquely inclined can be judged. Additionally, for example, the decoding means 33 makes this judgment. When a process is performed of superposing the image of the concealed region in the expanded image data as it stands in the case that the image has been obliquely inclined and has been rotated as against the camera, the image such that only the image of the concealed region frontally faces the camera is outputted notwithstanding the fact that the image of the not-concealed part has been obliquely inclined and has been rotated as against the camera. Therefore, for example, the decoding means 33 judges a parameter value indicative of the extent at which the image is rotated as against the camera, and the extent at which the image is obliquely inclined from the marker within the code, and the second embedding means 36 converts the image of the concealed region (designated region 72) so that it is rotated and inclined responding to the above parameter value, and makes the direction thereof identical to that of the not-concealed part. And, the second embedding means 36 superposes the image obtained by subjecting the image of the concealed region (designated region 72) to the conversion of the rotation and the inclination upon the photographed image. In this case, the image of which the entirety points to an identical direction can be outputted.

Further, as already explained, the image data of the image having an appropriate size can be generated because the process of the step S16 is performed by employing the position-aligning information with the arrangement position of the code defined to be a reference. That is, when the image (the image including the code), being a subject, is photographed from a far away point, the small image can be outputted as a before-concealment original image. Further, when the image, being a subject, is photographed from a near point, the large image can be outputted as a before-concealment original image.

Further, when compressing the image, the image compressing means 14 of the information concealing device may compress the input image data as it stands, and thereafter, may perform a process of the step S4 and the steps subsequent hereto. In this case, it follows that the code of the data obtained by compressing and encrypting the input image data as it stands is generated. Thus, performing the process of the step S15 and the steps before it in the information recovering device allows the input image data to be acquired. In this example, the input image data is acquired with the expanding process that is performed by the image expanding means 35 (step S15), whereby, for example, the second embedding means 36 may display the input image based upon the above input image data without the superposing process performed by the second embedding means 36. And, in the case of having moved the camera as against the image, being a subject, the part being displayed, out of the entirety of the image, is changed responding to the above movement. Further, in the case of allowing the camera to come near to or keeping the camera away from the image, being a subject, it is good enough to enlarge and reduce the display image responding to the above movement.

Further, in the step S3, the image compressing means 14 may compress the mask data beside the input image data. And, the coding means 16 may convert the encrypted data, the position-aligning information, and the mask data compressed by the image compressing means 14 in all into the image data expressing the code (for example, the two-dimensional code). The mask data can be compressed at a high compression ratio because it is data in which “1” is allotted to the data of the designated region, and “0” is allotted to the data of the region other than it. Thus, the quantity of the information that the coding means 16 should code can be suppressed at a low level. An operation of the information concealing device after generating the code is similar to the operation already explained. Further, in this case, the decoding means 33 of the information recovering device acquires the encrypted data, the position-aligning information, and the compressed mask data by decoding the code. After this decoding process (step S13), the image expanding means 35 may expand the compressed mask data, thereby to derive the before-compression mask data. After the before-compression mask data, the encrypted data, and the position-aligning information are acquired, the operation of the step S14 and the steps subsequent hereto already explained is performed.

Further, in the foregoing, the case that, in the coding by the information concealing device (step S5), the encrypted data, the position-aligning information, and the mask data in all were coded was explained. The coding means 16 may code the former two except for the mask data. In this case, the concealment region specifying means 13 generates the image data, which expresses only the designated region within the input image, and expresses the region other than it in a transparent color, in the step S2. The concealment region specifying means 13 generates, for example, the image data, which expresses only the designated region within the input image, and expresses the region other than it in a single color, similarly to the case already explained, and replaces the data of the pixel of the region other than the designated region with the data expressing the transparent color. The coding means 16 compresses this image data, and codes the encrypted data and the position-aligning information.

When the image is recovered from the code coded in such a manner, the second embedding means 36 makes a reference to the data decoded, decrypted, and expanded from the code instead of making a reference to the mask data. The second embedding means 36 make a reference to the data of each pixel in the image data decoded, decrypted, and expanded from the code, and determines whether each pixel indicates the designated region or the region other than it expressed in a transparent color. In the case that the pixel of the expanded image data expresses the designated region, the second embedding means 36 takes out the data of the above pixel from the expanded image data. On the other hand, in the case that the pixel of the expanded image data expresses the transparent color, the second embedding means 36 takes out the data of the pixel of the region within the concealment image corresponding to the above pixel, which the position-aligning information indicates, from the concealment image data. An operation other it in the step S16 is similar to the operation of the step S16 already explained. In this case, the mask data does not need to be coded.

### Embodiment 2

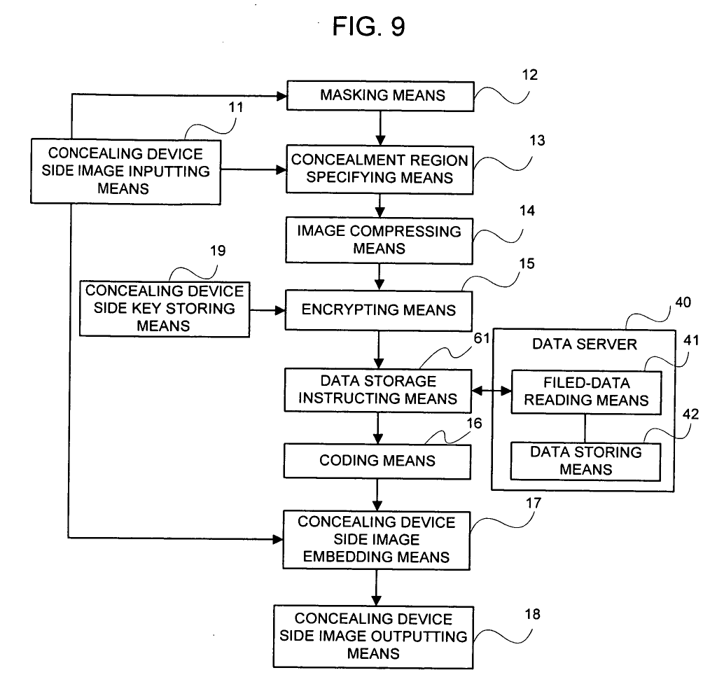

FIG. 9 is a block diagram illustrating an example of the information concealing device of the second embodiment. A numerical code identical to that of the first embodiment is affixed to a component similar to that of the first embodiment, and its detailed explanation is omitted. As shown in FIG. 9, the information concealing device of the second embodiment includes a first inputting means (concealing device side image inputting means) 11, a masking means 12, a concealment region specifying means 13, an image compressing means 14, an encrypting means 15, a coding means 16, a first embedding means (a concealing device side image outputting means) 18, a first key storing means (a concealing device side key storing means) 19, and a data storage instructing means 61. The information concealing device of the second embodiment differs from that of the first embodiment in a point of including the data storage instructing means 61. Further, an operation of the coding means 16 partially differs from that of the coding means 16 in the first embodiment.

Further, the data storage instructing means 61 of the information concealing device of the second embodiment is connected to a data server 40, for example, via a communication network (not shown in the figure). The data server 40 is a server device for storing the after-encryption data according to an instruction from the information concealing device, and further, transmitting the above data responding to a request from the information recovering device of this embodiment. At first, the data server will be explained. The data server 40 includes a data storing means 42 and a filed-data reading means 41.

The data storing means 42 is a storage device for storing the data (after-encryption) that is received from the information concealing device of this embodiment.

When having received the data from the data storage instructing means 61 of the information concealing device, the filed-data reading means 41 causes the data storing means 42 to store the above data. Further, the filed-data reading means 41 transmits to the data storage instructing means 61 an address of the data stored by the data storing means 42. The so-called address of the data stored by the data storing means 42 is, for example, URL (Uniform Resource Locator); however the address, which enables the data to be specified, is not limited to the URL.

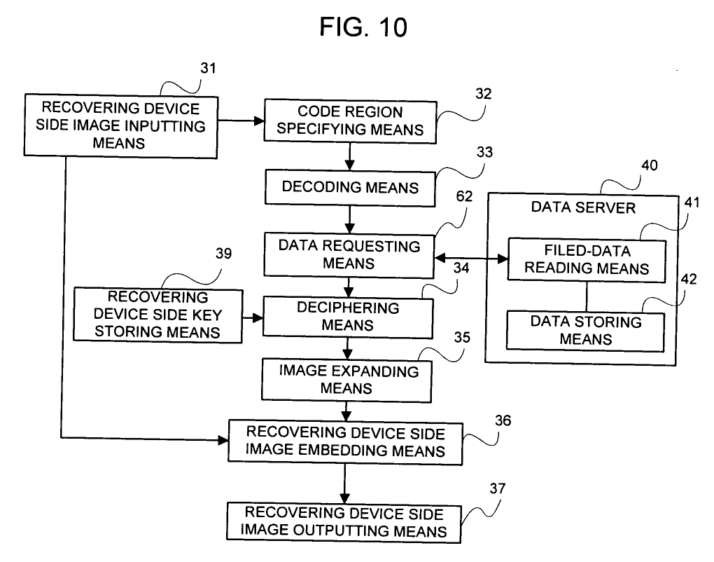

Further, when having received a request for the data from a data requesting means 62 (see FIG. 10) that the information recovering device of this embodiment includes, the filed-data reading means 41 reads out data corresponding to the designated address from the data storing means 42, and transmits the above data to the data requesting means 62 (see FIG. 10).

The filed-data reading means 41 is realized, for example, with an arithmetic processing device that operates according to a program.

The data storage instructing means 61 transmits the data encrypted by the encrypting means 15 to the data server 40, and instructs the data server 40 to store the above data. Further, the data storage instructing means 61 receives an address of the above data from the data server 40.

The coding means 16 converts the address received by the data storage instructing means 61 from the data server 40 into the image data expressing the code (one-dimensional code and the two-dimensional code). The coding means 16 converts not only the position-aligning information but also the mask data together with the address into the image data expressing the code.

The data storage instructing means 61 and the coding means 16 are realized, for example, with CPU that operates according to a program (information concealing program). The data storage instructing means 61 and the coding means 16 may be realized with CPU identical to the CPU for realizing the means other than them in the information concealing device.

FIG. 10 is a block diagram illustrating an example of the information recovering device of the second embodiment. A numerical code identical to that of the first embodiment is affixed to a component similar to that of the first embodiment, and its detailed explanation is omitted. As shown in FIG. 10, the information recovering device of the second embodiment includes a second inputting means (a recovering device side image inputting means) 31, a code region specifying means 32, a decoding means 33, a deciphering means 34, an image expanding means 35, a second embedding means (a recovering device side image embedding means) 36, a second key storing means (a recovering device side key storing means) 39, and the data requesting means 62. The information recovering device of the second embodiment differs from that of the first embodiment in a point of including the data requesting means 62.

The data requesting means 62 of the information recovering device of the second embodiment is connected to the foregoing data server 40, for example, via a communication network (not shown in the figure).

The information decoded by the decoding means 33 in this embodiment includes the address, the position-aligning information, and the mask data. The data requesting means 62 transmits the above address to the filed-data reading means 41, and requests the data corresponding to the address. And, the data requesting means 62 receives the data corresponding to the address from the filed-data reading means 41.

The data requesting means 62 is realized, for example, with CPU that operates according to a program (information recovering program). The data requesting means 62 may be realized with CPU identical to the CPU for realizing the means other than it in the information recovering device.

Next, an operation will be explained. At first, an operation of the information concealing device will be explained. The first inputting means 11 inputs the image, and continuously, the masking means 12 and the concealment region specifying means 13 specify the concealment region. Next, the image compressing means 14 compresses the image data generated by the concealment region specifying means 13, and besides, the encrypting means 15 encrypts the compressed data. The operation above is similar to that of the step S1 to the step S4 explained in the first embodiment.

Next, the data storage instructing means 61 transmits the data encrypted by the encrypting means 15 to the filed-data reading means 41, and makes a request for causing the data storing means 42 to stores the above data. The filed-data reading means 41, upon receipt of the request and the data coming from the data storage instructing means 61, causes the data storing means 42 to store the data (encrypted data) according to the above request. And, the filed-data reading means 41 transmits an address (for example, the URL) of the above data stored by the data storing means 42 to the data storage instructing means 61.

Additionally, the address can be expressed with a combination of an address of the data server 40 itself, a directory name for storing the data, and a file name of the data. In this case, pre-deciding the directory for allowing the data to be stored for each information concealing device, and uniquely deciding the file name of the data that the data storing means 42 stores make it possible to uniquely decide the address of the data that is stored. That is, when the filed-data reading means 41 causes the data storing means 42 to store the received data, the filed-data reading means 41 uniquely decides the file name of the above data, defines a combination of the above file name, the pre-decided address of the data server 40 itself, and the pre-decided directory name to be an address of the data, and transmits the above address of the data to the data storage instructing means 61. The filed-data reading means 41 defines, for example, a date and a time that the data has been received from the data storage instructing means 61 to be a file name, thereby enabling the file name to be uniquely decided. Or, the filed-data reading means 41 increments by 1 (one) a count value indicative of the number of the received data whenever it receives the data, and may define the above count value to be a file name.

The data storage instructing means 61 receives the address of the data from the filed-data reading means 41.

Continuously, the coding means 16 converts the position-aligning information, the mask data and the address received by the data storage instructing means 61 in all into the image data expressing the code (for example, the two-dimensional code). The coding means 16, similarly to the step S5 in the first embodiment, decides the position of the input image into which the two-dimensional code is embedded (namely, the position in which the two-dimensional code is arranged), and generates the position-aligning information, which indicates the position and the size of the input image in the case of having arranged the code in the input image, with the decided position defined to be a reference. The coding means 16 generates the image data expressing the two-dimensional code having the position-aligning information, the address, and the mask data arranged in a predetermined position thereof.

The first embedding means 17 hides the designated region (i.e. the encrypted region) within input image, and generates the image data indicative of the image having the two-dimensional code embedded therein. This process is similar to the operation of the step S6 in the first embodiment, and further, an output operation of the step S6 and the steps subsequent hereto is also similar to that of the first embodiment.

Next, an operation of the information recovering device will be explained. The second inputting means 31 inputs the image, which has information of one part of the region (the region designated by the concealing side user) hidden therein, and includes the code (for example, the two-dimensional code). And, the code region specifying means 32 specifies the region having the code arranged therein from the region of the inputted concealment image, and the decoding means 33 decodes the code. The operation above is similar to the operation of the step S11 to the step S13 in the first embodiment.

The decoded information includes the position-aligning information, the address and the mask data. The data requesting means 62 transmits the above address to the filed-data reading means 41, and requests the data stored in the above address. The filed-data reading means 41 reads out the data of the address received from the data requesting means 62 from the data storing means 42, and transmits the above data to the data requesting means 62. The data requesting means 62 receives the data from the filed-data reading means 41.

Next, the deciphering means 34 decrypts the data received by the data requesting means 62 from the filed-data reading means 41, and the image expanding means 35 expands the after-decryption data. The second embedding means 36 superposes the image of the concealed region upon the inputted concealment image. This operation is similar to the operation of the step S14 to the step S16 in the first embodiment. The output operation of the step S16 and the steps subsequent hereto is also similar to that of the first embodiment.

With this embodiment, the size of the code can be prevented from becoming large because the position-aligning information, the address and the mask data are coded. Additionally, there is no possibility that the data stored in the data server is perused by the third person who does not have the information recovering device because it cannot be decrypted when the key stored in the second storing means 39 does not exist.

Also in the second embodiment, the image compressing means 14 may carry out the resolution progressive compression, and the image expanding means 35 may expand the data subjected to the resolution progressive compression.

Further, when the image has been subjected to the resolution progressive compression, the image cannot be expanded only from a difference between each of the images having the different resolution and the other. For example, it is assumed that the image (image B) of ½ resolution is generated from the image (image A) having the original resolution, a difference between the image A and the image B is generated, and each of the image B and a difference between the image A and the image B is compressed. In this case, each of the image A and the image B cannot be expanded only from a difference between the image A and the image B. The encrypting means 15 may encrypt the image having the lowest resolution and a difference between each of the images having respective resolution levels and the other, respectively. And, the data storage instructing means 61 may transmit only the data obtained by encrypting the difference to the data server 40, thereby to cause the data server 40 to store it. And, the coding means 16 may code the data not stored by the data server 40 (the data obtained by encrypting the image having the lowest resolution), the address received from the data server 40, the position-aligning information, and the mask data. In this case, even though the third person, who has acquired the key unjustly, has accessed the data stored by the data storing means 42, he/she cannot recover the image because he/she can acquire only the data of the difference, which can enhance safetiness that the data being concealed does not leak all the more. Further, the coding means 16 may divide the data, thereby to cause plural servers to store them. To do so makes it possible to enhance safetiness that the data being concealed does not leak all the more.

Also in the second embodiment, the masking means 12 may divide the region designated by the concealing side user into plural regions when the size of the encrypted data is larger than a threshold. And, the process of the generation of the mask data and the steps subsequent hereto may be performed for each region divided by the masking means 12. Further, or, the encrypted data is divided, and the operation of the step in which the data storage instructing means 61 requests the filed-data reading means 41 to cause the data storing means 42 to store the data, and the steps subsequent hereto may be performed for each of the divided pieces of the data. The data division is carried out, for example, by the coding means 16; however the other means of the information recovering device may carry out the data division.

Further, in the case that the image has been obliquely inclined as against the camera, and has been rotated, as explained in the first embodiment, for example, the decoding means 33 judges a parameter value indicative of the extent at which the image is rotated as against the camera, and the extent at which the image is obliquely inclined from the marker within the code, and the second embedding means 36 may convert the image of the concealed region (designated region 72) so that it is rotated and inclined responding to the above parameter, and may superpose it in a direction identical to that of the not-yet-concealed part.

Further, when compressing the image, the image compressing means 14 of the information concealing device may compress the input image data as it stands. In this case, for example, the second embedding means 36 may display the image based upon the after-expansion image data without the superposition performed by the second embedding means 36.

Further, in the foregoing, the case of coding the mask data together with the position-aligning information and the address was explained; however the data server 40 may store the mask data. That is, the data storage instructing means 61 may transmit not only the encrypted data but also the mask data to the filed-data reading means 41, thereby to make a request for causing the data storing means 42 to stores both of the encrypted data and the mask data. The filed-data reading means 41, upon receipt of the request and the data coming from the data storage instructing means 61, causes the data storing means 42 to store the data (the encrypted data and the mask data) according to the above request, and transmits to the data storage instructing means 61 an address of the above data stored by the data storing means 42. After the data storage instructing means 61 has received the address from the filed-data reading means 41, the coding means 16 converts the above address and the position-aligning information in all into the image data expressing the code (for example, the two-dimensional code). Further, in this case, the decoding means 33 of the information recovering device acquires the position-aligning information and the address by decoding the code. After this decoding process, the data requesting means 62 transmits the above address to the filed-data reading means 41, and requests the data stored in the above address. And, the filed-data reading means 41 reads out the data of the address received from the data requesting means 62 (encrypted data and the mask data) from the data storing means 42, and transmits the above data to the data requesting means 62, and the data requesting means 62 receives the above data from the filed-data reading means 41. The operation subsequent hereto is similar to the operation of the first embodiment already explained. Further, in the case of causing the data server 40 to store the mask data in such a manner, the image compressing means 14 may compress the mask data, and the data storage instructing means 61 may cause the data server 40 to store the encrypted data and the above-compressed mask data. In this case, after the data requesting means 62 of the information recovering device has received the after-compression mask data from the data server 40, the image expanding means 35 expands the above after-compression mask data, and returns the mask data into a before-compression status.

Also in the second embodiment, the position-aligning information and the address may be coded without the mask data coded. In this case, the concealment region specifying means 13 generates the image data, which expresses only the designated region within the input image, and expresses the region other than it in a transparent color, in the step S2. Further, the second embedding means 36 of the information recovering device makes a reference to each pixel of the image data, which expresses only the designated region within the input image, and expresses the region other than it in a transparent color, determines whether each pixel indicates the designated region or the region other than it expressed in a transparent color, and takes out the data of the pixel from the above image data or the concealment image data according to the above determination result.

Further, in the foregoing, the case that, when the filed-data reading means 41 caused the data storing means 42 to store the data, it decided the address, and transmitted the above address to the data storage instructing means 61 was explained. When the data storage instructing means 61 transmits the data to the filed-data reading means 41, thereby to make a request so that the above data is stored, it may uniquely decide an address of the above data, and may transmit the above address to the data server 40. For example, it is assumed that the directory for storing the data has been pre-decided for each of the information concealing devices in the data server 40. The data storage instructing means 61 uniquely decides a file name of the data, and defines a combination of the above file name, a pre-decided address of the data server 40 itself, and a pre-decided directory name to be an address of the data. The data storage instructing means 61 defines a date and a time that the data is transmitted to the filed-data reading means 41 to be a file name, thereby enabling the file name of the data to be uniquely decided. Or, the data storage instructing means 61 may increment by 1 (one) a count value indicative of the transmission number of the data whenever it transmits the data, and may define the above count value to be a file name. The coding means 16 codes the address decided by the data storage instructing means 61. Further, when the filed-data reading means 41 has received the data and the address, it causes the pre-decided directory to store the data received under the file name being included in the above address.

### Embodiment 3

The information concealing device and the information recovering device of the third embodiment assume a configuration similar to the configuration of the information concealing device and the information recovering device of the second embodiment, respectively, so the explanation associated with the configuration is omitted. However, each of the information concealing device and the information recovering device of the third embodiment performs operations of both of the first embodiment and the second embodiment.

Hereinafter, an operation of this embodiment will be explained.

In this embodiment, the information concealing device, similarly to the information concealing device of the first embodiment, performs the operation of the step S2 (see FIG. 3) and the step before it. The image compressing means 14 generates the image data that is obtained by lowering the resolution of the image data generated in the step S2 (the image data, which expresses the designated region within the input image, and expresses the region other than the designated region in a single color. See FIG. 4(d)). However, the image compressing means 14 leaves the image data as well behind, which is not resolution-lowered, without scrapping it. The image compressing means 14 prepares a copy of the image data that has not been resolution-lowered yet, and for each of plural pixels of the copied image data, replaces the above plural pixels with one pixel, thereby to lower the resolution of the image data. As a result, two kinds of pieces of the image data generated in the step S2 and the resolution-lowered image data are acquired.

From now on, the information concealing device in this embodiment performs the operation of the step S3 and the steps subsequent hereto (see FIG. 3) of the first embodiment for the resolution-lowered image data. This operation is similar to that of the first embodiment, so its explanation is omitted.

Further, the information concealing device performs the image data compressing operation (the operation equivalent to the step S3) of the second embodiment and the operations subsequent hereto for the image data that has not been resolution-lowered yet (the image data generated in the step S2). This operation is similar to that of the second embodiment, so its explanation is omitted.

As a result, the code including of the address of the image data that has not been resolution-lowered yet (the image data generated in the step S2) and the code including the image data obtained by compressing and encrypting the resolution-lowered image data are superposed upon the input image. Additionally, the coding means 16 decides an arrangement position for each of the two kinds of the codes so that the two kinds of the codes are not overlapped, and the first embedding means superposes the images of the codes in the above arrangement positions, respectively.

Further, the information recovering device in this embodiment operates as follows. The second inputting means 31 inputs the image including the two kinds of the codes. And the code region specifying means 32 specifies the arrangement position for each code. The operation above is similar to that of the step S11 and the step S12. Further, the decoding means 33 decodes each code of which the arrangement position has been specified. This operation is similar to that of the step S13.

Similarly to the case of the first embodiment, the position-aligning information, the encrypted data, and the mask data are decoded from the coded code, and similarly to the case of the second embodiment, the position-aligning information, the address, and the mask data are acquired from the coded code.

The information recovering device firstly employs the position-aligning information, the encrypted data, and the mask data, thereby to perform the operation similar to the step S14 and the steps subsequent hereto in the first embodiment. This operation is similar to that of the first embodiment, so its explanation is omitted. Herein, the encrypted data is data obtained by compressing and encrypting the resolution-lowered image data. Thus, the second outputting means 37 outputs the image obtained by superposing the resolution-lowered image. Thus, it follows that the reader peruses the image having a low resolution as an image obtained by recovering the concealed region.

When, for example, the reader performs a manipulation of instructing the display of the image having a high resolution, the information recovering device employs the position-aligning information, the address, and the mask data, thereby to perform the operation of requesting of the data server 40 the data (the operation that the data requesting means 62 requests of the data server 40 the data) and the operations subsequent hereto in the second embodiment. This operation is similar to that of the second embodiment, so its explanation is omitted. The image being acquired in this operation is an image that has not been resolution-lowered. Thus, it follows that the reader peruses the image having a high resolution as an image obtained by recovering the concealed region.

Additionally, the information recovering device of this embodiment includes manipulating means such as a keyboard and a switch for performing a manipulation of instructing the display of the image having a high resolution by the reader. Further, the aspect of this operation is not limited particularly.

With this embodiment, the image having a low resolution is firstly displayed, and the detailed image having a higher resolution can be displayed responding to a request by the reader.

In this embodiment, the image compressing means 14 may subject the image data generated by the concealment region specifying means 13 to the resolution progressive compression. And, the operation of the step S4 and the steps subsequent hereto in the first embodiment may be performed for the image having a low resolution (for example, the exemplified image C having a ¼ resolution (32×32)), which is obtained with the resolution progressive compression, and the operation of the encryption (the operation equivalent to the step S4) and the steps subsequent hereto in the second embodiment may be performed for a difference between the above image having a low resolution and the original image. When the information recovering device outputs the image having a low resolution, it recovers the image by employing the image data having a low resolution acquired with the resolution progressive compression. When the information recovering device outputs the image having a high resolution, it requests of the data server 40 a difference between the image having a low resolution and the image having a high resolution, and outputs the image having a high resolution from the above difference and the data of the image having a low resolution.

Further, in the foregoing, the case that, when the reader performed a manipulation of instructing the display of the image having a high resolution, the information recovering device displayed the image having a high resolution was explained. In this embodiment, displaying the image having a high resolution necessitates much more time as compared with the time required for displaying the image having a low resolution because the information recovering device makes communication with the data server 40. Thereupon, a configuration may be employed in which the operation being performed until the image having a low resolution is displayed and the operation being performed until the image having a high resolution is displayed are performed in parallel even though the reader does not make a manipulation, the image having a low resolution keeps to be displayed until the information recovering device completes the communication with the data server 40, thereby making the image having a high resolution displayable, and at the moment that the image having a high resolution has been made displayable, the above image having a high resolution is displayed.

Further, also in this embodiment, a configuration may be made so that the image data, which expresses only the designated region within the input image, and expresses the region other than it in a transparent color, is generated, and the mask data is prevented from being coded at the moment of the coding process.

### Embodiment 4

The information concealing device and the information recovering device of the fourth embodiment assume a configuration similar to the configuration of the information concealing device and the information recovering device of the first embodiment, respectively, so the explanation associated with the configuration is omitted.

Hereinafter, an operation of this embodiment will be explained.

In this embodiment, the information concealing device, similarly to the information concealing device of the first embodiment, performs the operation of the step S2 (see FIG. 3) and the step before it. And, the image compressing means 14 generates the image data that is obtained by lowering the resolution of the image data (the image data, which expresses the designated region within the input image, and expresses the region other than the designated region in a single color. See FIG. 4(d)) generated in the step S2. However, the image compressing means 14 leaves the image as well behind, which is not resolution-lowered, without scrapping it. The image compressing means 14 prepares a copy of the image data that has not been resolution-lowered yet, and for each of plural pixels of the copied image data, replaces the above plural pixels with one pixel, thereby to lower the resolution of the image data. As a result, two kinds of pieces of the image data generated in the step S2 and the resolution-lowered image data are acquired. This operation is similar to that of the image compressing means 14 of the third embodiment.

From now on, the information concealing device in this embodiment performs the operation of the step S3 and the steps subsequent hereto (see FIG. 3) in the first embodiment for each of the resolution-lowered image data and the image data generated in the step S2. This operation is similar to that of the first embodiment, so its explanation is omitted.

However, in this embodiment, the coding means 16 carries out the coding to the two-dimensional code in the step S5. That is, the coding means 16 converts the encrypted data, the position-aligning information, and the mask data in all into the image data expressing the two-dimensional code. Further, when coding the data obtained by compressing and encrypting the resolution-lowered image data, as well as, when coding the data obtained by compressing and encrypting the image data that has not been resolution-lowered, the coding means 16 changes the size of the cell (dot) being included in the two-dimensional code. The coding means 16 makes the cell within the two-dimensional code corresponding to the resolution-lowered image data larger than the cell within the two-dimensional code corresponding to the image data that has not been resolution-lowered.

As a result, each of the code being generated from the image data that has not been resolution-lowered (the image data generated in the step S2), and the code being generated from the resolution-lowered image data is superposed upon the input image. Additionally, the coding means 16 decides an arrangement position for each of the two kinds of the codes so that the two kinds of the codes are not overlapped, and the first embedding means superposes the images of the codes in the above arrangement positions, respectively.

Further, the information recovering device in this embodiment operates as follows. The second inputting means 31 inputs the image including the two kinds of the two-dimensional codes. And the code region specifying means 32 specifies the arrangement position for each two-dimensional code. The operation above is similar to that of the step S11 and the step S12.

Next, the decoding means 33 decodes each two-dimensional code of which the arrangement position has been specified. When the decoding means 33 was able to decode each of the two kinds of the two-dimensional codes, the information recovering device employs the data decoded from the two-dimensional code having a smaller cell (the two-dimensional code corresponding to the image data that has not been resolution-lowered), thereby to perform the operation of the encryption of the step S5 and the steps subsequent hereto. When the decoding means 33 was able to decode only one kind of the two-dimensional code, the information recovering device employs the data decoded from the above two-dimensional code, thereby to perform the operation of the encryption of the step S5 and the steps subsequent hereto.

The so-called case that the decoding means 33 can decode the data only from one kind of the two-dimensional code is a case that the decoding means 33 cannot read the cell of the two-dimensional code having a smaller cell. For example, it is assumed that the second inputting means 31 is a camera. When the image, being a subject, and the camera, being the second inputting means 31, are close to each other in a distance, each of the two kinds of the two-dimensional codes can be photographed clearly (in a sufficient resolution). However, the case occurs that, while the cell of the two-dimensional code having a larger cell can be photographed clearly (in a sufficient resolution) when the image, being a subject, and the camera are away from each other, the cell of the two-dimensional code having a smaller cell cannot be photographed in a sufficient resolution. At this time, while the decoding means 33 can decode the data from the two-dimensional code having a larger cell, it cannot decode the data from the two-dimensional code having a smaller cell. At this time, the information recovering device performs the operation of the encryption of the step S5 and the steps subsequent hereto by employing the data decoded from the two-dimensional code having a larger cell (the two-dimensional code corresponding to the image data that has not been resolution-lowered).

The operation of the step S5 and the steps subsequent hereto is similar to that of the first embodiment, so its explanation is omitted.

Also in this embodiment, a configuration may be made so that the image data, which expresses only the designated region within the input image, and expresses the region other than it in a transparent color, is generated, and the mask data is prevented from being coded at the moment of the coding process.

This embodiment makes it possible to display the image having a high resolution when the two-dimensional code having a larger cell can be decoded, and to display the resolution-lowered image even though the image having a high resolution cannot be displayed when the two-dimensional code having a smaller cell can be decoded.

In each of the above-mentioned embodiments, the information concealing device may not include either the image compressing means 14 or the encrypting means 15, or both.

When the information concealing device does not include the encrypting means 15, the information concealing device, after generating the after-compression data, may proceed to the next process without performing the process of the step S4. For example, the information concealing device may code the after-compression data, or may cause the data server 40 to store it. In this case, the information recovering device may not include the deciphering means 34. And, the information recovering device, after performing the decoding process, may proceed to the next process without performing the process of the deciphering process of the step S14. For example, the information recovering device expands the decoded data, and requests of the data server 40 the data that corresponds to the address being included in the decoded data.

When the information concealing device does not include the image compressing means 14, the information concealing device may proceed to the next process without performing the process of the step S3 for the image being acquired in the step S2. In this case, the information recovering device may not include the image expanding means 35. And, the information concealing device, after the encrypting process, may proceed to the next process without performing the expanding process of the step S15.

When the information concealing device does not include the image compressing means 14 and the encrypting means 15, the information concealing device may proceed to the next process without performing the process of the step S3 and the step S4 for the image being acquired in the step S2. In this case, the information recovering device may include the deciphering means 34 and the image expanding means 35. And, the information concealing device, after the decoding process, may proceed to the next process without performing the process of the step S14 and the step S15.

This application is based upon and claims the benefit of priority from Japanese patent application No. 2006-329486, filed on Dec. 6, 2006, the disclosure of which is incorporated herein in its entirety by reference.

### HOW THE INVENTION IS CAPABLE OF INDUSTRIAL EXPLOITATION

The present invention can be preferredly applied to the information concealing device for concealing one part of the region being included in the image so that the third person cannot peruse it, and the information recovering device for perusing the concealed information.

1. An information concealing device comprising:
a masking unit for urging a user to designate a region being concealed in an input image, being an image that has been inputted;
a concealment region specifying unit for generating image data, which expresses the image of the region designated in the input image, and expresses the region other than the designated region in a single color;
an encoder for converting the image data, which expresses the image of the region designated in the input image, and expresses the region other than the designated region in a single color, into the image data expressing a code; and
an embedding unit for generating the image data of the image expressing the region designated in the input image in a single color, and embedding the code into said image.

2. An information concealing device according to claim 1:
wherein said information concealing device comprises an image compressor for compressing the image data generated by the concealment region specifying unit; and
wherein the encoder converts the compressed image data into the image data expressing the code.

3. An information concealing device according to claim 1:
wherein said information concealing device comprises an encrypting unit for encrypting the image data generated by the concealment region specifying unit; and
wherein the encoder converts the encrypted image data into the image data expressing the code.

4. An information concealing device according to claim 1:
wherein said information concealing device comprises:
an image compressor for compressing the image data generated by the concealment region specifying unit, and
an encrypting unit for encrypting the compressed image data; and
wherein the encoder converts the encrypted image data into the image data expressing the code.

5. An information concealing device according to claim 4:
wherein the image compressor generates resolution-lowered image data from the image data generated by the concealment region specifying unit, and compresses both of first image data generated by the concealment region specifying unit and resolution-lowered second image data;
wherein the encrypting means unit encrypts both of the compressed first image data and the compressed second image data; and
wherein the encoder converts the compressed and encrypted first image data into the image data expressing a two-dimensional code, and converts the compressed and encrypted second image data into the image data expressing a two-dimensional code of which a cell is larger than that of said two-dimensional code.

6. An information concealing device that is connected to a data server for storing image data, and puts an image into a unreadable status, said information concealing device comprising:
a masking unit for urging a user to designate a region, which should be concealed, in an input image, being an image that has been inputted;
a concealment region specifying unit for generating image data that expresses the image of the region designated in the input image, and expresses the region other than the designated region in a single color;
a data storage instructing unit for transmitting the image data, which expresses the image of the region designated in the input image, and expresses the region other than the designated region in a single color, to the data server, and causing the data server to store it;
an encoder for converting an address of the image data stored to the data server into the image data expressing a code; and
an embedding unit for generating the image data of the image that expresses the region designated in the input image in a single color, and embedding the code into said image.

7. An information concealing device according to claim 6:
wherein said information concealing device further comprises an image compressor for compressing the image data generated by the concealment region specifying unit, and
wherein the data storage instructing unit transmits the compressed image data to the data server and causes the data server to store it.

8. An information concealing device according to claim 6:
wherein said information concealing device further comprises an encrypting unit for encrypting the image data generated by the concealment region specifying unit, and
wherein the data storage instructing unit transmits the encrypted image data to the data server and causes the data server to store it.

9. An information concealing device according to claim 6:
wherein said information concealing device further comprises:
an image compressor for compressing the image data generated by the concealment region specifying unit; and
an encrypting unit for encrypting the compressed image data, and
wherein the data storage instructing unit transmits the encrypted image data to the data server and causes the data server to store it.

10. An information concealing device according to claim 9:
wherein the image compressor generates resolution-lowered image data from the image data generated by the concealment region specifying unit, and compresses both of first image data generated by the concealment region specifying unit and resolution-lowered second image data;
wherein the encrypting unit encrypts both of the compressed first image data and the compressed second image data;
wherein the data storage instructing unit transmits the compressed and encrypted first image data to the data server and causes the data server to store it; and
wherein the encoder converts each of the address of the image data stored to the data server and the compressed and encrypted second image data into the image data expressing the code.

11. An information recovering device for recovering an hidden image from a concealment image including the code, of which one part has been hidden, wherein said information recovering device comprises:
a decoder for decoding the code being included in the concealment image to before-coding data; and
an image data generator for generating the image data of the image having the hidden image included within the concealment image thereof by employing the decoded data and the image data of the concealment image.

12. An information recovering device according to claim 11:
wherein said information recovering device further comprises an image expander for expanding the compressed data to the before-compression data; and
wherein the image expander expands the decoded data to the before-compression image data; and
wherein the image data generator generates the image data of the image having the hidden image included within the concealment image thereof by employing the expanded image data and the image data of the concealment image.

13. An information recovering device according to claim 11:
wherein said information recovering device further comprises a deciphering unit for decrypting the encrypted data;
wherein the deciphering unit decrypts the decoded data; and
wherein the image data generator generates the image data of the image having the hidden image included within the concealment image thereof by employing the decrypted image data and the image data of the concealment image.

14. An information recovering device according to claim 11:
wherein said information recovering device further comprises:
a deciphering unit for decrypting the encrypted data; and
an image expander for expanding the compressed data to the before-compression data,
wherein the deciphering unit decrypts the decoded data;
wherein the image expander expands the decrypted data to the before-compression image data; and
wherein the image data generator generates the image data of the image having the hidden image included within the concealment image thereof by employing the expanded image data and the image data of the concealment image.

15. An information recovering device according to claim 14:
wherein the decoder decodes two kinds of two-dimensional codes, i.e. a first two-dimensional code being included in the concealment image, and a second two-dimensional code of which a cell is larger than that of said first two-dimensional code; and
wherein the deciphering unit decrypts the data decoded from the first two-dimensional code when the decoder has succeeded in decoding each of the first two-dimensional code and the second two-dimensional code.

16. An information recovering device that recovers a hidden image from a concealment image including the code, of which one part has been hidden, and has been connected to a data server for storing image data, said information recovering device comprising:
a decoder for decoding the code being included in the concealment image to a before-coding address;
a data requesting unit for transmitting said address to the data server, and receiving the image data corresponding to said address from the data server; and
an image data generator for generating the image data of the image having the hidden image included within the concealment image thereof by employing the image data received by the data requesting means unit and the image data of the concealment image.

17. An information recovering device according to claim 16:
wherein said information recovering device further comprises an image expander for expanding the compressed data to the before-compression data;
wherein the image expander expands the image data received from the data server to the before-compression image data; and
wherein the image data generator generates the image data of the image having the hidden image included within the concealment image thereof by employing the expanded image data and the image data of the concealment image.

18. An information recovering device according to claim 16:
wherein said information recovering device further comprises a deciphering unit for decrypting the encrypted data;
wherein the deciphering unit decrypts the image data received from the data server; and
wherein the image data generator generates the image data of the image having the hidden image included within the concealment image thereof by employing the decrypted image data and the image data of the concealment image.

19. An information recovering device according to claim 16:
wherein said information recovering device further comprises:
a deciphering unit for decrypting the encrypted data; and
an image expander for expanding the compressed data to the before-compression data;
wherein the deciphering unit decrypts the image data received from the data server;
wherein the image expander expands the decrypted image data to the before-compression image data; and
wherein the image data generator generates the image data of the image having the hidden image included within the concealment image thereof by employing the expanded image data and the image data of the concealment image.

20. An information recovering device according to claim 19:
wherein the decoder decodes two kinds of codes including a first code obtained by coding the address, and a second code obtained by coding the image data;
wherein the data requesting unit transmits the address decoded from the first code to the data server, and receives the image data corresponding to said address from the data server;
wherein the deciphering unit decrypts both of the image data received from the data server and the image data decoded from the second code;
wherein the image expander expands each of the decrypted two kinds of pieces of the image data to the before-compression image data; and
wherein the image data generator generates the image data of the image having the hidden image included within the concealment image thereof by employing the image data obtained by decrypting and expanding the image data decoded from the second code, and the image data of the concealment image, and generates the image data of the image having the hidden image included within the concealment image thereof by employing the image data obtained by decrypting and expanding the image data received from the data server, and the image data of the concealment image

21. An information concealing method:
wherein a masking unit urges a user to designate a region, which should be concealed, in an input image, being an image that has been inputted;
wherein a concealment region specifying unit generates image data that expresses the image of the region designated in the input image, and expresses the region other than the designated region in a single color;
wherein a encoder converts the image data, which expresses the image of the region designated in the input image, and expresses the region other than the designated region in a single color, into the image data expressing a code; and
wherein an embedding unit generates the image data of the image that expresses the region designated in the input image in a single color, and embeds the code into said image.

22. An information concealing method:
wherein a masking unit urges a user to designate a region, which should be concealed, in an input image, being an image that has been inputted;
wherein a concealment region specifying unit generates image data that expresses the image of the region designated in the input image, and expresses the region other than the designated region in a single color;
wherein a data storage instructing unit transmits the image data, which expresses the image of the region designated in the input image, and expresses the region other than the designated region in a single color, to a data server, and causes the data server to store it;
wherein a encoder converts an address of the image data stored by the data serve into the image data expressing a code; and
wherein an embedding unit generates the image data of the image that expresses the region designated in the input image in a single color, and embeds the code into said image.

23. An information recovering method:
wherein a decoder decodes a code within a concealment image including the code, of which one part has been hidden, to before-coding data; and
wherein an image data generator generates image data of the image having the hidden image included within the concealment image thereof by employing the decoded data and the image data of the concealment image.

24. An information recovering method:
wherein a decoder decodes a code within a concealment image including the code, of which one part has been hidden, to a before-coding address;
wherein a data requesting unit transmits said address to a data server and receives image data corresponding to said address from the data server; and
wherein an image data generator generates the image data of the image having the hidden image included within the concealment image thereof by employing the image data received by the data requesting unit and the image data of the concealment image

25. A recording medium in which an information concealing program is stored, said information concealing program for causing a computer to execute:
a masking process of urging a user to designate a region, which should be concealed, in an input image, being an image that has been inputted;
a concealment region specifying process of generating image data that expresses the image of the region designated in the input image, and expresses the region other than the designated region in a single color;
a coding process of converting the image data, which expresses the image of the region designated in the input image, and expresses the region other than the designated region in a single color, into image data expressing a code; and
an embedding process of generating the image data of the image that expresses the region designated in the input image in a single color, and embedding the code into said image.

26. A recording medium in which an information concealing program is stored, said information concealing program for causing a computer to execute:
a masking process of urging a user to designate a region, which should be concealed, in an input image, being an image that has been inputted;
a concealment region specifying process of generating image data that expresses the image of the region designated in the input image, and expresses the region other than the designated region in a single color;
a data storage instructing process of transmitting the image data, which expresses the image of the region designated in the input image, and expresses the region other than the designated region in a single color, to a data server, and causing the data server to store it;
a coding process of converting an address of the image data stored to the data server into image data expressing a code; and
an embedding process of generating the image data of the image that expresses the region designated in the input image in a single color, and embedding the code into said image.

27. A recording medium in which an information concealing program is stored, said information recovering program for causing a computer to execute:
a decoding process of decoding a code within a concealment image including the code, of which one part has been hidden, to before-coding data; and
an image data generating process of generating the image data of the image having the hidden image included within the concealment image thereof by employing the decoded image data and the image data of the concealment image.

28. A recording medium in which an information concealing program is stored, said information recovering program for causing a computer to execute:
a decoding process of decoding a code within a concealment image including the code, of which one part has been hidden, to a before-coding address;
a data requesting process of transmitting said address to a data server and receiving the image data corresponding to said address from the data server, and
an image data generating process of generating the image data of the image having the hidden image included within the concealment image thereof by employing the image data received in the data requesting process and the image data of the concealment image.
